(19) United States
(12) Patent Application Publication
(10) Pub. No.: US 2009/0172033 A1
(43) Pub. Date: Jul. 2, 2009

(54) Methods, systems and computer-readable media for facilitating forensic investigations of online activities

(75) Inventors: David William Clark, Carp (CA); Stephane Maxime Francois Fortier, Breakeyville (CA); Jean Bouchard, Sillery (CA); Sanro Zlobec, Notre-Dame-de-I'IIe-Perrot (CA)

Correspondence Address: SMART & BIGGAR, 1000 DE LA GAUCHETIERE ST. W., SUITE 3300, MONTREAL, QC, H3B 4W5, CA

(73) Assignee: BCE INC., Montreal (CA)

(21) Appl. No.: 12/314,735

(22) Filed: Dec. 16, 2008

Related U.S. Application Data
(60) Provisional application No. 61/017,329, filed on Dec. 28, 2007.

(30) Foreign Application Priority Data
Jun. 2, 2008 (CA) 2,633,227

(51) Int. Cl. G06F 17/30

(52) U.S. Cl. 707/104.1; 707/E17.044

(57) ABSTRACT

Methods, systems and computer-readable media containing program code for facilitating forensic investigations of online activities such as online transactions. One method for facilitating an investigation comprises: receiving a logical identifier and temporal information; consulting a database to obtain evidentiary information regarding end-user equipment to which was assigned the logical identifier at a time specified by the temporal information; and using the evidentiary information to transmit a message, which can be used by a party conducting the investigation, for instance, to detect or establish that the transaction is fraudulent or illegal.

### CROSS-REFERENCE TO RELATED APPLICATIONS

This application claims the benefit under 35 USC 119(e) of U.S. Provisional Patent Application 61/017,329 filed on Dec. 28, 2007 and hereby incorporated by reference herein, and claims the benefit under 35 USC 119(a) of Canadian Patent Application 2,633,227 filed on Jun. 2, 2008 and hereby incorporated by reference herein.

### FIELD OF THE INVENTION

The invention relates generally to online activities (e.g., online transactions) and, more particularly, to methods, systems and computer-readable media for facilitating forensic investigations of such activities.

### BACKGROUND

Various online activities can be effected by users of end-user equipment connected to a data network such as the Internet. For example, online transactions such as purchases of products, services or content via a web site are increasingly popular.

While most transactions conducted online are genuine, there is a certain amount of fraud involving online transactions, and the ensuing financial loss suffered by merchants continues to increase annually. Also, the distributed nature of the Internet tends to facilitate the availability of products or services whose procurement may in actual fact be illegal due to the purchaser's age, location or other attribute. While investigations into possible fraud or illegality of a conventional transaction are straightforward, the same cannot be said about online transactions where scarce data, if any, about the true individual who made the transaction remains traceable after the fact.

Similar difficulties may also be encountered when investigating other types of online activities, such as a user's browsing sessions or chat sessions (e.g., via instant messaging (IM) or chat rooms).

Against this background, there is a need for solutions that will facilitate forensic investigations of online transactions and other online activities.

### SUMMARY OF THE INVENTION

According to a first broad aspect, the invention provides a method for facilitating an investigation. The method comprises: receiving a logical identifier and temporal information; consulting a database to obtain evidentiary information regarding end-user equipment to which was assigned the logical identifier at a time specified by the temporal information; and using the evidentiary information to transmit a message.

According to a second broad aspect, the invention provides a system for facilitating an investigation. The system comprises an interface configured to receive a logical identifier and temporal information. The system also comprises a processing unit coupled to the interface and configured to: consult a database to obtain evidentiary information regarding end-user equipment to which was assigned the logical identifier at a time specified by the temporal information; and use the evidentiary information to transmit a message.

According to a third broad aspect, the invention provides computer-readable media containing program code which, when interpreted by a computing apparatus, causes the computing apparatus to execute a process for facilitating an investigation. The program code comprises: first program code for causing the computing apparatus to be attentive to receipt of a logical identifier and temporal information; second program code for causing the computing apparatus to consult a database to obtain evidentiary information regarding end-user equipment to which was assigned the logical identifier at a time specified by the temporal information; and third program code for causing the computing apparatus to use the evidentiary information to cause transmission of a message.

According to a fourth broad aspect, the invention provides a system for facilitating an investigation. The system comprises: means for receiving a logical identifier and temporal information; means for consulting a database to obtain evidentiary information regarding end-user equipment to which was assigned the logical identifier at a time specified by the temporal information; and means for using the evidentiary information to transmit a message.

According to a fifth broad aspect, the invention provides a method for investigating an online activity. The method comprises: determining a logical identifier assigned to end-user equipment used for the online activity and a time of the online activity; requesting an entity to obtain evidentiary information regarding the end-user equipment based on the logical identifier and the time; receiving a message transmitted by the entity upon obtaining the evidentiary information; and deriving a conclusion concerning the online activity based on the message.

According to a sixth broad aspect, the invention provides a method for conducting an investigation. The method comprises: transmitting information regarding a particular person or location considered in the investigation; receiving a logical identifier assigned to end-user equipment and temporal information regarding when the logical identifier was assigned to the end-user equipment, the logical identifier and the temporal information being associated in a database with the information regarding the particular person or location; and identifying an online activity initiated using the end-user equipment to which was assigned the logical identifier at a time specified by the temporal information.

According to a seventh broad aspect, the invention provides a method for facilitating an investigation. The method comprises: receiving information regarding a particular person or location considered in the investigation; consulting a database on a basis of the information regarding the particular person or location to obtain a logical identifier assigned to end-user equipment and temporal information regarding when the logical identifier was assigned to the end-user equipment; and transmitting the logical identifier and the temporal information.

According to an eight broad aspect, the invention provides a method for facilitating an investigation. The method comprises: receiving first information comprising at least two of (i) a logical identifier assigned to end-user equipment, (ii) a particular time at which the end-user equipment was used for an online activity, and (iii) presumed evidentiary information regarding the end-user equipment; consulting a database on a basis of the first information to obtain second information comprising: (a) the logical identifier, if the particular time and the presumed evidentiary information have been received; (b) temporal information regarding when the logical identifier was assigned to the end-user equipment, if the logical identifier and the presumed evidentiary information have been received; or (c) actual evidentiary information, if the logical identifier and the particular time have been received; and using the second information to transmit a message destined for a party conducting the investigation.

According to a ninth broad aspect, the invention provides a system for facilitating an investigation. The system comprises an interface configured to receive first information comprising at least two of: a logical identifier assigned to end-user equipment; a particular time at which the end-user equipment was used for an online activity; and presumed evidentiary information regarding the end-user equipment. The system also comprises a processing unit coupled to the interface and configured to: consult a database on a basis of the first information to obtain second information comprising: (a) the logical identifier, if the particular time and the presumed evidentiary information have been received; (b) temporal information regarding when the logical identifier was assigned to the end-user equipment, if the logical identifier and the presumed evidentiary information have been received; or (c) actual evidentiary information, if the logical identifier and the particular time have been received; and use the second information to transmit a message destined for a party conducting the investigation.

According to a tenth broad aspect, the invention provides computer-readable media containing program code which, when interpreted by a computing apparatus, causes the computing apparatus to execute a process for facilitating an investigation. The program code comprises: first program code for causing the computing apparatus to be attentive to receipt of first information comprising at least two of: (i) a logical identifier assigned to end-user equipment; (ii) a particular time at which the end-user equipment was used for an online activity; and (iii) presumed evidentiary information regarding the end-user equipment; second program code for causing the computing apparatus to consult a database on a basis of the first information to obtain second information comprising: (a) the logical identifier, if the particular time and the presumed evidentiary information have been received; (b) temporal information regarding when the logical identifier was assigned to the end-user equipment, if the logical identifier and the presumed evidentiary information have been received; or (c) actual evidentiary information, if the logical identifier and the particular time have been received; and third program code for causing the computing apparatus to use the second information to cause transmission of a message destined for a party conducting the investigation.

According to an eleventh broad aspect, the invention provides a system for facilitating an investigation. The system comprises: means for receiving first information comprising at least two of: (i) a logical identifier assigned to end-user equipment; (ii) a particular time at which the end-user equipment was used for an online activity; and (iii) presumed evidentiary information regarding the end-user equipment; means for consulting a database on a basis of the first information to obtain second information comprising: (a) the logical identifier, if the particular time and the presumed evidentiary information have been received; (b) temporal information regarding when the logical identifier was assigned to the end-user equipment, if the logical identifier and the presumed evidentiary information have been received; or (c) actual evidentiary information, if the logical identifier and the particular time have been received; and means for using the second information to transmit a message destined for a party conducting the investigation.

These and other aspects of the invention will become apparent to those of ordinary skill in the art upon review of the following description of certain embodiments of the invention in conjunction with the accompanying drawings.

### BRIEF DESCRIPTION OF THE DRAWINGS

A detailed description of embodiments of the invention is provided herein below, by way of example only, with reference to the accompanying drawings, in which:

FIG. 1 shows an architecture allowing a user of end-user equipment connected to a data network to effect online activities such as online transactions, in accordance with an embodiment of the invention;

FIG. 2 shows possible contents of a database that stores information associated with various logical identifiers assigned to various end-user equipment used to access the data network shown in FIG. 1;

FIG. 3 shows an example of message flow in the architecture of FIG. 1, in the context of attempting to effect an online transaction;

FIG. 4 shows an example of message flow following FIG. 3 once the online transaction has been approved or denied;

FIGS. 5A to 5C show examples of message flow that can take place during a forensic investigation of a transaction of interest; and

FIGS. 6 to 8 are block diagrams and flow diagrams illustrating an example process to create an association between logical identifiers assigned to end-user equipment, temporal information regarding when these logical identifier were assigned to such end-user equipment, and evidentiary information regarding such end-user equipment, this association being useful in populating the database of FIG. 2.

It is to be expressly understood that the description and drawings are only for the purpose of illustration of certain embodiments of the invention and are an aid for understanding. They are not intended to be a definition of the limits of the invention.

### DETAILED DESCRIPTION OF EMBODIMENTS

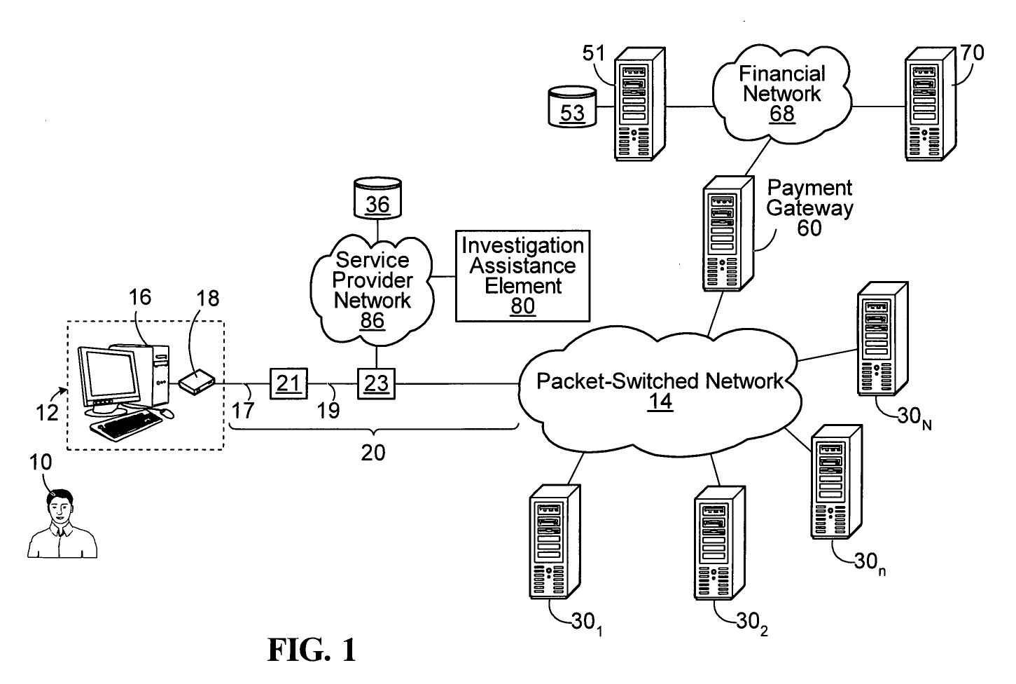

FIG. 1 depicts a packet-switched network 14 to which are connected a plurality of servers 30₁ . . . 30_{N} that implement network sites. Various end-user equipment that gain access to the packet-switched network 14 can interact with the network sites and/or with one another in order to effect online activities. The network sites may include merchant sites, search engine sites, social networking sites, content sites, corporate sites, personal sites and various other types of sites. Online activities that can be effected when accessing the packet-switched network 14 may include online browsing sessions, online transactions, online chat sessions (e.g., via instant messaging (IM) or chat rooms), and various other activities that can be performed online. In a non-limiting embodiment, the packet-switched network 14 is the Internet and the network sites are web sites.

The servers 30₁ . . . 30_{N} and the network sites that they implement are operated, managed or otherwise associated with various entities, such as companies, governmental organizations, non-profit organizations, and individuals. Each of the servers 30₁ . . . 30_{N} comprises suitable hardware, firmware, software, control logic, or a combination thereof for implementing a plurality of functional components, including an interface and a processing unit.

The interface of each of the servers 30₁ . . . 30_{N} is adapted to receive messages from, and send messages to, various end-user equipment and other communication apparatus connected to the packet-switched network 14, as well as to receive messages from, or send messages to, other elements (e.g., computers or databases) communicatively coupled to that server but not necessarily connected to the packet-switched network 14.

The processing unit of each of the servers 30₁ . . . 30_{N} is adapted to effect various processing operations to implement that server's functionality. For example, when a user uses his/her end-user equipment to interact with a given network site implemented by a given one of the servers 30₁ . . . 30_{N}, this will typically involve a network browser implemented by the end-user equipment interacting with the given one of the servers 30₁ . . . 30_{N} in order to allow the user to view, hear or otherwise be exposed to content (e.g., web pages) of the given network site via a display and/or one or more other output devices of the end-user equipment, and to input information (e.g., by entering text, clicking on a graphical button or hyperlink, pressing a command key) via one or more input devices of the end-user equipment.

Access to the packet-switched network 14 is controlled or managed by a service provider that has a number of subscribers. In various non-limiting embodiments, the service provider may be an Access Service Provider (ASP), a Regional Access Network Provider (RANP) or an Internet Service Provider (ISP). Individual subscribers are given permission to access the packet-switched network 14 when using certain authorized end-user equipment and/or when providing certain authorized login credentials.

One example of end-user equipment 12 that may be used to access the packet-switched network 14 by a user 10 is shown in FIG. 1. Specifically, the end-user equipment 12 comprises a computing device 16 and a network interface unit 18. The computing device 16 may be implemented as a personal computer (PC), such as a desktop computer, a laptop computer or a tablet PC. The computing device 16 is provided with at least one input device such as a keyboard, a mouse, a touchscreen, a stylus, a microphone, etc., as well as a display and possibly one or more other output devices (e.g., speakers) that enable interaction with the user 10. The computing device 16 is operative to run a software application implementing a network browser (e.g., a web browser) with which the user 10 can interact via the display (and possibly the one or more other output devices) and the at least one input device in order to access and interact with network sites of the packet-switched network 14.

A communication link 20 is provided between the end-user equipment 12 and the packet-switched network 14. The network interface unit 18 interfaces with the communication link 20 and enables the computing device 16 to exchange data with the packet-switched network 14 (and, ultimately, with the network sites and/or other computing devices connected to the packet-switched network 14). For example, depending on the nature of the communication link 20, the network interface unit 18 may be implemented as a modem such as a broadband modem (e.g., a digital subscriber line (DSL) modem or a cable modem) or a narrowband modem (e.g., a dial-up modem). In other embodiments, such as in the case of fiber-to-the-premises (FTTP), the network interface unit 18 may be implemented as an optical network termination (ONT)-based Ethernet connection. Although it is shown as being a separate component in FIG. 1, the network interface unit 18 may be integrated into the computing device 16 (e.g., it may be a card internal to the computing device 16).

The communication link 20 may traverse one or more network elements and comprise one or more physical links and one or more logical links. For example, the communication link 20 may comprise a physical link 17 between the network interface unit 18 and a network element 21. The physical link 17 may comprise a copper twisted pair, a coax cable, an Ethernet link, a fiber optic link (e.g., FTTP), a fixed wireless link, a satellite link, or a combination thereof. Depending on the nature of the physical link 17, the network element 21 may be a DSL access multiplexer (DSLAM), a cable modem termination system (CMTS), or another type of network element. The communication link 20 may also comprise a dedicated logical link 19 between the network element 21 and another network element 23 that provides access to the packet-switched network 14. For instance, the network element 23 may be a network access server (NAS), a router, etc. It will be appreciated that the communication link 20 may take on other forms in other embodiments.

For the purposes of exchanging data with the packet-switched network 14, the end-user equipment 12 may be assigned a logical identifier. In two non-limiting embodiments, the logical identifier may be assigned to the computing device 16 or to the network interface unit 18. The logical identifier, which can be an Internet Protocol (IP) address (e.g., in compliance with IPv4 or IPv6) or a proprietary address, label or tag, can be assigned in a static or dynamic fashion. In the static case (e.g., a static IP address), the logical identifier does not change over time. In the dynamic case (e.g., a dynamic IP address), the logical identifier may change over time (e.g., a dynamic IP address).

Assignment of the logical identifier to the end-user equipment 12 can be effected under control of the service provider and may be the responsibility of a designated network element that is part of the communication link 20, such as the network element 23 (particularly in embodiments where the network element 23 is a network access server). The designated network element may assign the logical identifier to the end-user equipment 12 when the end-user equipment 12 is activated (e.g., when the network interface unit 18 and/or the computing device 16 is/are powered-up) or otherwise regains network connectivity and/or at certain time intervals which may range from an hour or less to several months or more. For instance, in embodiments where the logical identifier is a dynamic IP address, the designated network element assigning the dynamic IP address to the end-user equipment 12 may do so in accordance with the Dynamic Host Configuration Protocol (DHCP) using a pool of IP addresses accessible to that network element. It will be recognized that assignment of the logical identifier to the end-user equipment 12 may be effected in different ways in different embodiments.

In accordance with an embodiment of the invention, the service provider maintains a database 36 that stores information associated with various logical identifiers assigned to various end-user equipment used to access the packet-switched network 14. The database 36 can be linked to various components of the architecture of FIG. 1 in different ways. For example, in one embodiment, the database 36 may be integrated with the network element 23. In another embodiment, the database 36 may be connected to the network element 23 either directly or via a service provider network 86, for example. In still other embodiments, the database 36 may be distributed amongst a plurality of network elements and/or physical locations (i.e., different portions of its information content can be stored in memories of different network elements and/or at different physical locations). Also, it should be appreciated that, in some embodiments, the database 36 may be managed, maintained and/or updated by an entity different from the service provider responsible for providing the end-user equipment 12 with access to the packet-switched network 14.

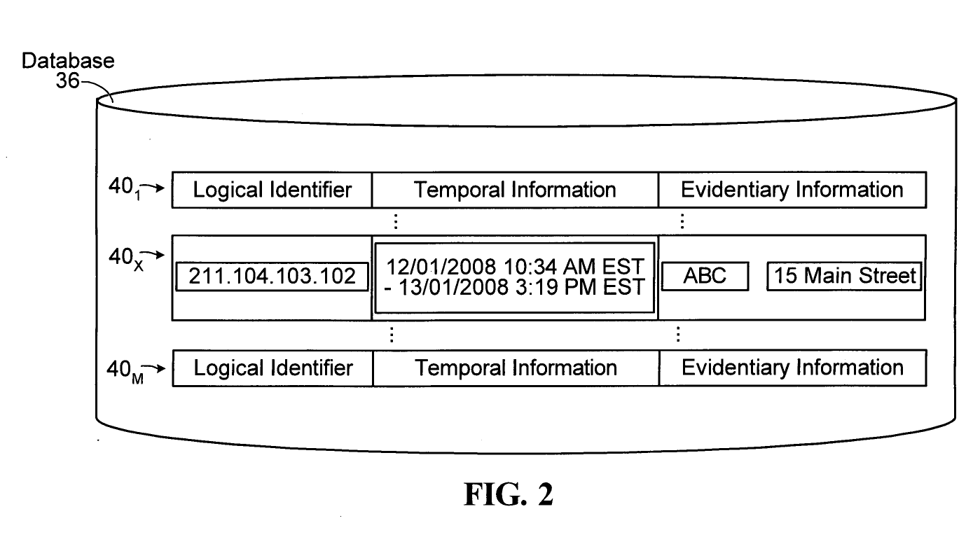

With additional reference to FIG. 2, there is shown an example of possible contents of the database 36. An example process by which the database 36 may be populated and maintained is described later on. For the time being, it is sufficient to consider that the database 36 stores a plurality of records 40₁ . . . 40_{M} for a plurality of logical identifiers assigned to various end-user equipment used to access the packet-switched data network 14. The contents of the database 36 are kept up to date as changes that affect logical identifiers assigned to various end-user equipment take place.

The record for a given logical identifier assigned to given end-user equipment contains temporal information regarding when the given logical identifier was assigned to the given end-user equipment. For example, the temporal information may indicate a time (e.g., a date and/or time of day) at which the given logical identifier was initially assigned to the given end-user equipment, and/or a period of time for which the given logical identifier was assigned to the given end-user equipment (e.g., respective dates and/or times of day at which the given logical identifier was initially assigned and stopped being assigned to the given end-user equipment).

The record for a given logical identifier also contains “evidentiary information” regarding the end-user equipment to which the given logical identifier was assigned. Evidentiary information can be viewed as information that can serve as evidence towards establishing who has attempted/effected an online activity and/or where that online activity was attempted/effected from. The value of evidentiary information can be high when investigating online activities, particularly days or weeks after they have taken place. Such analysis may be commissioned by, inter alia, financial institutions (such as banks, credit card companies, etc.), as well as government bodies (such as law enforcement agencies, taxation departments, etc.).

The evidentiary information that can be contained in a given one of the records 40₁ . . . 40_{M} is not particularly limited and may take on various forms, some of which are best illustrated by way of example.

Accordingly, a first example of evidentiary information that can be contained in the record for a given logical identifier includes personal information (such as a name; age or date of birth; gender; telephone number; email address; service provider account identifier; service provider billing information such as a billing address, credit card number and/or bank account number; etc.) regarding a particular subscriber whose credentials were supplied via the end-user equipment to which the given logical identifier was assigned, when access to the packet-switched network 14 was sought.

A second example of evidentiary information that can be contained in the record for a given logical identifier includes location information indicative of where the end-user equipment to which the given logical identifier was assigned was located, when access to the packet-switched network 14 was sought. Such location information may specify a location of a “service point” at which the end-user equipment was determined to be located. The “service point” refers to a point where a network access service is provided to a subscriber by the service provider. For example, the service point may be a house or other building, or an area thereof. The location of the service point, which is hereinafter referred to as the “service point location”, may be expressed as a geo location (e.g., latitude, longitude, elevation, and the datum which identifies the coordinate system used, such as, without limitation, the World Geodetic System 1984 (WGS841) datum). Alternatively or in addition, the service point location may be expressed as a civic location (a set of elements that describe detailed street address information). It will be recognized that the location information may take on various other forms in other embodiments.

With continued reference to FIG. 1, in accordance with an embodiment of the invention, the service provider operates a network element 80, hereinafter referred to as an “investigation assistance element”, which can be used to access the database 36 in order to provide assistance in investigations of online activities attempted/effected using various end-user equipment (such as the end-user equipment 12) connected to the packet-switched network 14. In some embodiments, the investigation assistance element 80 and the database 36 may be part of separate network elements that are connected to one another directly or via the service provider network 86. In other embodiments, the investigation assistance element 80 and the database 36 may be part of a common network element.

The investigation assistance element 80 comprises suitable hardware, firmware, software, control logic, or a combination thereof for implementing a plurality of functional components, including an interface and a processing unit. The interface of the investigation assistance element 80 is adapted to receive messages from and send messages to other servers, computers and/or other elements (e.g., databases). The processing unit of the investigation assistance element 80 is adapted to effect various processing operations to implement that server's functionality.

In order to illustrate how the investigation assistance element 80 may be used to provide assistance in investigations of online transactions, an example in which the user 10 attempts to effect an online transaction via a network site implemented by a given one of the servers 30₁ . . . 30_{N} will be considered below. Before proceeding with this example, other network elements which may be involved in processing online transactions are first discussed.

As shown in FIG. 1, some online transactions attempted to be effected by various end-user equipment (such as the end-user equipment 12) may involve a payment gateway 60 and/or a financial network 68. The payment gateway 60 is a network element that is connected to the financial network 68 and that may be used by one or more of the servers 30₁ . . . 30_{N} to process online transactions attempted to be made via the network sites implemented by these one or more servers. The financial network 68 interconnects a plurality of servers or other computers associated with banks and/or other financial institutions. Examples of servers that could be interconnected via the financial network 68 include a transaction validation server 51 that could be associated with, for example, a card issuing bank and a server 70 that could be associated with, for example, an acquiring bank. It should be appreciated that in certain embodiments, the financial network 68 may be part of the packet-switched network 14, may comprise individual point-to-point links or may be dispensed with altogether.

The transaction validation server 51 is operated, managed or otherwise associated with an entity responsible for validating online transactions. In a specific non-limiting embodiment, this entity may be a card issuing bank that issues credit cards or debit cards. The transaction validation server 51 comprises suitable hardware, firmware, software, control logic, or a combination thereof for implementing a plurality of functional components, including an interface and a processing unit. The interface of the transaction validation server 51 is adapted to receive messages from and send messages to other servers and/or other computers, and to exchange messages with other elements (e.g., databases). The processing unit of the transaction validation server 51 is adapted to effect various processing operations to implement that server's functionality.

The transaction validation server 51 includes or has access to a database 53, which stores information used by the transaction validation server 51 to validate online transactions attempted to be effected by various users. Accordingly, the database 53 stores a plurality of records, each of which is associated with a respective “transaction object” and contains “transaction object information” pertaining to the respective transaction object, as well as ancillary information that may be required to process an online transaction attempted to be made using the respective transaction object.

A “transaction object” refers to any physical or virtual object designed to be used in an attempt to make a transaction. For example, a transaction object may constitute a payment card (e.g., a credit card, a debit card, etc.), an account (e.g., a bank account, an online wallet account, login credentials for accessing secure content or a VPN, etc.), an electronic check, a set of one or more digital cash (electronic money) certificates, or any other physical or virtual object designed to be used in an attempt to make a transaction.

The transaction object information contained in a particular record of the database 53 depends on the nature of the transaction object associated with the particular record and can thus take on various forms. For example:
The transaction object information may include payment card information regarding a payment card in situations where, for instance, the user 10 desires to purchase or otherwise obtain a product/service/content offered on a network site, pay a bill for a previously obtained product/service/content via the network site, or make a donation to a charity or other institution through the network site using the payment card. Such payment card information may be, for instance, credit card information regarding a credit card (e.g., a number, expiry date, and/or holder's name) or debit card information regarding a debit card (e.g., a number and/or holder's name). The payment card may comprise one or more card elements adapted to convey part or all of the payment card information, such as one or more sets of characters (e.g., printed and/or embossed characters), a magnetic stripe, and/or a chip (e.g., an EMV chip).
The transaction object information may include electronic check information regarding an electronic check (e.g., a check number and/or a checking account number) in situations where, for instance, the user 10 desires to effect a payment via a network site using the electronic check. In order to process the payment attempted to be effected by the user 10 using the electronic check, an entity (e.g., a bank or other financial institution, or the service provider) that allows the user 10 to use the electronic check may store on a computer-readable medium (e.g., as part of a database) information regarding the electronic check, including the electronic check information provided by the user 10.
The transaction object information may include digital cash information regarding a set of one or more digital cash certificates (e.g., digital cash certificate identifiers) in situations where, for instance, the user 10 desires to effect a payment via a network site using the set of one or more digital cash certificates. In order to process the payment attempted to be effected by the user 10 using the set of one or more digital cash certificates, an entity (e.g., a bank or other financial institution) that allows the user 10 to use the set of one or more digital cash certificates may store on a computer-readable medium (e.g., as part of a database) information regarding the set of one or more digital cash certificates, including the digital cash information provided by the user 10.
The transaction object information may include account information regarding an account (e.g., an account number and/or holder's name and/or login credentials) in situations where, for instance, the user 10 desires to effect a transfer of funds to or from the account via a network site, or where the user 10 desires to access secure online content or a VPN via the network site. In order to process the attempted transfer or access, an entity (e.g., a bank or other financial institution, a corporate extranet server) that allows the user 10 to use the account may store on a computer-readable medium (e.g., as part of a database) information regarding the account, including the account information provided by the user 10.

The ancillary information contained in a particular record of the database 53 also depends on the nature of the transaction object associated with the particular record and can thus take on many forms. For example, where the transaction object associated with the particular record is a credit card, the ancillary information contained in the particular record may include a credit limit, a balance due, a billing address (i.e., an address where credit card bills are to be sent), a shipping address, a list of recent transactions, a list of one or more authorized transaction points (which could include the billing address and/or the shipping address), a list of one or more unauthorized transaction points, a spatio-temporal history of previous online transactions attempted using that credit card, a list of eligible card holders' names and/or possibly other information regarding the credit card.

For purposes of this example, it is assumed that the user 10 has used the end-user equipment 12 to successfully gain access to the packet-switched network 14, and that a logical identifier, say 211.104.103.102, was assigned to the end-user equipment 12 at a certain time, say 10:34 AM EST on Jan. 12, 2008, until a later time, say 3:19 PM EST on Jan. 13, 2008 (when, for instance, access to the packet-switched network 14 stopped or was lost or another logical identifier was assigned to the end-user equipment 12). Successful access to the packet-switched network 14 may have been gained by the user 10 having provided the credentials of a legitimate subscriber, say, subscriber “ABC”, via the end-user equipment 12. Thus, with reference to FIG. 2, the database 36 stores a record 40_{X} for logical identifier 211.104.103.102, which contains evidentiary information regarding the end-user equipment 12. For instance, the evidentiary information may include an identity of subscriber “ABC” (or other personal information regarding subscriber “ABC”) whose credentials have been provided via the end-user equipment 12. Alternatively or additionally, the service provider may determine a service point location, say “15 Main Street”, associated with the end-user equipment 12 and may store this information in the record 40_{X}. One way in which the service point location associated with the end-user equipment 12 can be determined is described in greater detail later on.

It is further assumed that, at a particular time, say 1:48 PM EST on Jan. 12, 2008, the user 10 attempts to effect an online transaction with the network site implemented by the server 30ₙ. For example, the user 10 may attempt to: purchase or otherwise obtain a product and/or a service and/or content offered on the network site; pay a bill for a previously obtained product/service/content via the network site; transfer funds from one account to another via the network site; buy or sell securities (e.g., stocks, bonds, etc.) via the network site; make a donation to a charity or other institution through the network site; etc. It will be appreciated that various other situations may arise in which online transactions may be desired or may need to be effected. The user 10 may express that he/she wants to attempt to effect the online transaction in various ways, such as by selecting a “check-out” option or going through another suitable transaction confirmation process on the network site.

In the course of attempting to effect the online transaction while interacting with the network site implemented by the server 30ₙ, the user 10 provides transaction object information via the end-user equipment 12. This can be done in various ways. For example, the user 10 may use one or more of the at least one input device of the computing device 16 to enter the transaction object information and cause this information to be sent by the end-user equipment 12 to the server 30ₙ (or another computer associated with the server 30ₙ) over the packet-switched network 14. Alternatively, the transaction object information may have been previously stored in the computing device 16, in which case the user 10 may use one or more of the at least one input device of the computing device 16 to cause the end-user equipment 12 to send the previously stored transaction object information to the server 30ₙ (or another computer associated with the server 30ₙ) over the packet-switched network 14.

For purposes of this example, it is assumed that: the transaction object used by the user 10 in attempting to effect the online transaction is a particular credit card issued to a Mr. John Smith (who may or may not be the user 10) and having credit card number 4513000000001; the transaction object information is credit card information regarding the particular credit card, say the card holder's name “John Smith” and the card number's “4513000000001”; and the transaction validation server 51 is a server associated with a card issuing bank that issued the particular credit card. Also, for purposes of this example, each of the records in the database 53 is associated with a credit card and includes credit card information regarding that credit card. One of these records may be associated with the particular credit card and thus may include credit card information regarding the particular credit card (e.g., credit card holder “John Smith” and credit card number 4513000000001).

The online transaction attempted to be effected by the user 10 may be subjected to various conventional security measures intended to protect information traveling to and from the end-user equipment 12 over the packet-switched network 14. For example, the credit card information provided by the user 10 via the end-user equipment 12 may be encrypted (e.g., using the Secure Socket Layer (SSL) protocol) prior to being sent over the packet-switched network 14. In other examples, card security code (CSC) verification may be employed whereby the user 10 is asked to enter the credit card's CSC, and/or address verification systems (AVS) may be employed whereby an address entered by the user 10 is compared to a billing address known to the credit card's issuing bank. Various other security measures may be employed in different cases.

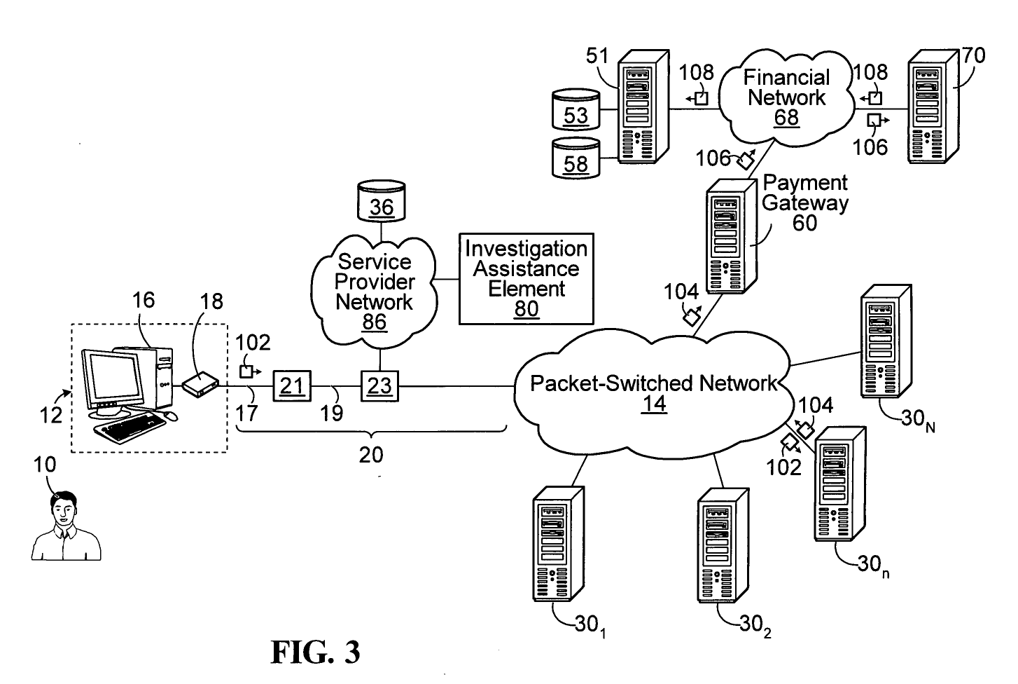

With reference now to FIG. 3, the computing device 16 of the end-user equipment 12 transmits to the server 30ₙ a message 102. In this example, the message 102 conveys: (i) order information indicative of the selected product/service/content; (ii) purchase amount information indicative of an amount to be paid to purchase the selected product/service/content; and (iii) the credit card information regarding the particular credit card. Alternatively, the order information, the purchase amount information and possibly even the credit card information may already be known to the server 30ₙ due to prior interaction between the computing device 16 and the server 30ₙ. In such a case, the message 102 may simply convey an indication or confirmation of a desire of the user 10 to purchase the selected product/service/content.

Additionally, the message 102 may convey the logical identifier assigned to the end-user equipment 12, in this case 211.104.103.102. Alternatively, the logical identifier assigned to the end-user equipment 12 may not be conveyed by the message 102 but may already be known to the server 30ₙ due to prior interaction between the computing device 16 and the server 30ₙ.

The message 102 is received at the server 30ₙ, which proceeds to derive temporal information regarding the particular time, in this case 1:48 PM EST on Jan. 12, 2008, at which the user 10 attempted to effect the online transaction. This temporal information may indicate the particular time itself and/or another sufficiently close reference time, such as the time at which the message 102 is received. For example, the server 30ₙ may implement or have access to a clock to record the particular time at which the user 10 attempted to effect the online transaction or the time at which the message 102 is received. As a possible alternative, in some embodiments, the message 102 may convey the temporal information regarding the particular time at which the user 10 attempted to effect the online transaction.

The server 30ₙ proceeds to send a message 104 to the payment gateway 60. In this example, the payment gateway 60 is used by the server 30ₙ to process online transactions attempted to be made via the network site implemented by the server 30ₙ. Thus, the manner in which the payment gateway 60 can be reached may be known in advance to the server 30ₙ. It is recalled that the financial network 68 interconnects the payment gateway 60 to the transaction validation server 51 (which is associated with the card issuing bank that issued the particular credit card) and the server 70 (which is associated with the acquiring bank used by an entity, in this case a merchant, that operates, manages or is otherwise associated with the server 30ₙ).

The message 104 sent to the payment gateway 60 may be identical to the message 102, i.e., it may be a relayed version of the message 102 when the message 102 contains sufficient information. Alternatively, the message 104 may be generated by the server 30ₙ based on the message 102 and possibly other information known to the server 30ₙ (e.g., the order information, the purchase amount information, the credit card information, the temporal information regarding the particular time at which the user 10 attempted to effect the online transaction, and/or the logical identifier assigned to the end-user equipment 12). Ultimately, in this example, the message 104 conveys: (i) the purchase amount information indicative of an amount to be paid to purchase the selected product/service/content; (ii) the credit card information regarding the particular credit card; (iii) the temporal information regarding the particular time at which the user 10 attempted to effect the online transaction; and (iv) the logical identifier assigned to the end-user equipment 12.

The message 104 is received at the payment gateway 60, which determines that the message 104 originates from the server 30ₙ and proceeds to send a message 106 over the financial network 68 to the server 70 (which, it is recalled, is associated with the acquiring bank used by the merchant associated with the server 30ₙ). The message 106, which can be viewed as a request for transaction authorization, is intended to elicit from the financial network 68 a response as to whether the transaction attempted by the user 10 is approved or denied. In this example, the payment gateway 60 generates the message 106 based on the message 104 such that the message 106 conveys: (i) the purchase amount information indicative of an amount to be paid to purchase the selected product/service/content; (ii) the credit card information regarding the particular credit card; (iii) the temporal information regarding the particular time at which the user 10 attempted to effect the online transaction; and (iv) the logical identifier assigned to the end-user equipment 12. Also, in this embodiment, the payment gateway 60 generates a transaction identifier, say “A7GY8P2”, for the online transaction and generates the message 106 such that it conveys this transaction identifier.

The server 70 receives the message 106 and processes it to gain knowledge that an attempt is being made to effect a transaction involving the merchant associated with the server 30ₙ. Based on the credit card information conveyed by the message 106, the server 70 proceeds to send a message 108 to the transaction validation server 51 over the financial network 68. The message 108 may be identical to the message 106, i.e., it may be a relayed version of the message 106. Alternatively, the message 108 may be generated by the server 70 based on the message 106 and possibly other information known to the server 70. In this example, the message 108 conveys: (i) the purchase amount information indicative of an amount to be paid to purchase the selected product/service/content; (ii) the credit card information regarding the particular credit card; (iii) the temporal information regarding the particular time at which the user 10 attempted to effect the online transaction; (iv) the logical identifier assigned to the end-user equipment 12; and (v) the transaction identifier for the online transaction.

The message 108 is received at the transaction validation server 51, which is associated with the card issuing bank that issued the particular credit card that has been used by the user 10 to attempt to purchase the selected product/service/content. The transaction validation server 51 proceeds to process the message 108 to determine whether the online transaction attempted to be effected by the user 10 is to be approved or denied. To this end, the transaction validation server 51 consults the database 53 to identify a particular one of the records therein for the credit card information conveyed by the message 108 (in this case, credit card holder “John Smith” and credit card number 4513000000001).

The transaction validation server 51 may perform various processing operations to determine whether the online transaction attempted to be effected by the user 10 is to be approved or denied. For example, based on the ancillary information (e.g., a credit limit, a balance due, etc.) included in the particular one of the records in the database 53 and the purchase amount information conveyed by the message 108, the transaction validation server 51 may determine whether the online transaction is to be approved or denied. It will be appreciated that approval or denial of the online transaction may be determined by the transaction validation server 51 based on other factors in addition to or instead of those mentioned above.

Additionally, in this embodiment, the transaction validation server 51 creates in a database 58 a record associating: (i) the transaction identifier for the online transaction (in this case, A7GY8P2); (ii) the credit card information regarding the particular credit card (in this case, credit card holder “John Smith” and credit card number 4513000000001); (iii) the temporal information regarding the particular time at which the user 10 attempted to effect the online transaction (in this case, 1:48 PM EST on Jan. 12, 2008); and (iv) the logical identifier assigned to the end-user equipment 12 (in this case, 211.104.103.102), which are conveyed by the message 108. Alternatively, this association may be stored in the database 53, for instance, as part of the record associated with the particular credit card corresponding to that credit card information. In other embodiments, the record created by the transaction validation server 51 may contain: (i) the transaction identifier for the online transaction; (ii) the temporal information regarding the particular time at which the user 10 attempted to effect the online transaction; and (iii) the logical identifier assigned to the end-user equipment 12, in which case the credit card information regarding the particular credit card may be stored in a record in another database (e.g., the database 53) and linked to the transaction identifier. As will be illustrated later on, such an association may prove valuable when it comes to launching a possible investigation into potential fraudulence or illegality of the online transaction attempted to be effected by the user 10.

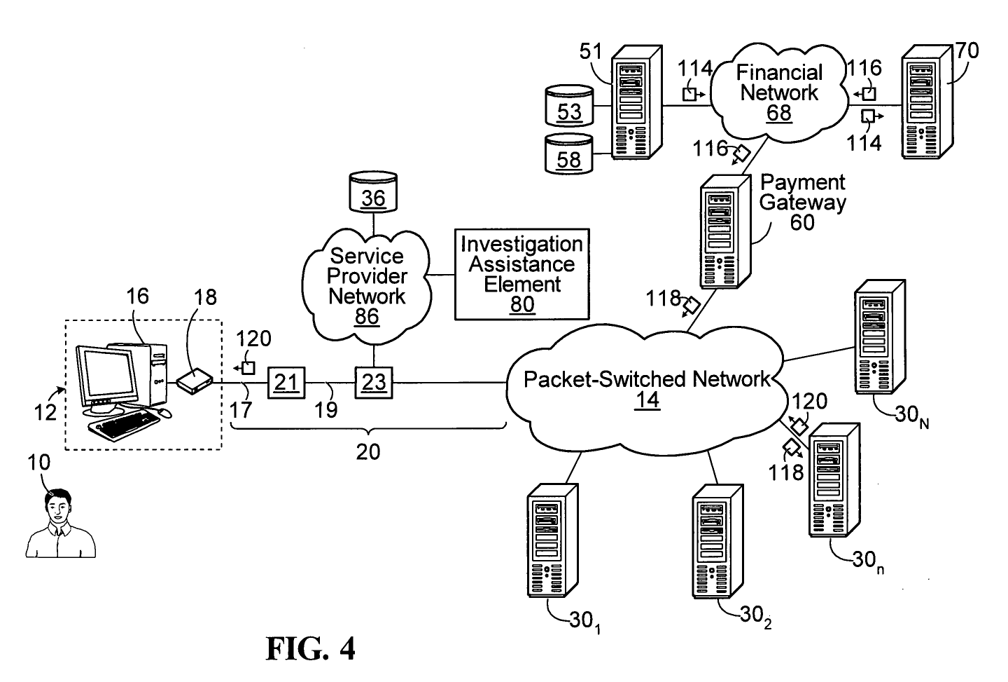

With reference now to FIG. 4, upon determining whether the online transaction attempted to be effected by the user 10 is approved or denied, the transaction validation server 51 returns a message 114 to the server 70 over the financial network 68. The message 114 indicates whether the online transaction attempted to be effected by the user 10 was approved or denied.

If the online transaction attempted to be effected by the user 10 was denied, the message 114 may indicate (e.g., by a code) a reason for this denial, such as insufficient funds, an unavailable bank link, etc. Depending on the circumstances, the transaction validation server 51 may also take further action, such as freezing a credit account corresponding to the particular credit card used by the user 10, informing security/law enforcement authorities, etc.

On the other hand, if the online transaction attempted to be effected by the user 10 was approved, the transaction validation server 51 may update, in the database 53, the record associated with the particular credit card to take into account approval of this transaction. For example, one or more items of ancillary information (e.g., a balance due, an available credit, etc.) included in the record in question may be updated to reflect the fact that the online transaction was approved.

The server 70 receives the message 114 and processes it to determine whether the online transaction attempted to be effected by the user 10 was approved or denied. If approved, this online transaction is eventually settled via a settlement process involving the acquiring bank and the card issuing bank. This settlement process is well known and thus not described herein. Meanwhile, the server 70 proceeds to return a message 116 to the payment gateway 60. The message 116 may be identical to the message 114, i.e., it may be a relayed version of the message 114.

Alternatively, the message 116 may be generated by the server 70 based on the message 114. The message 116 indicates whether the online transaction attempted to be effected by the user 10 was approved or denied and, if denied, may indicate a reason therefor.

The message 116 is received at the payment gateway 60, which proceeds to send a message 118 to the server 30ₙ. The message 118 indicates whether the online transaction attempted to be effected by the user 10 was approved or denied and, if denied, may indicate a reason therefor.

The server 30ₙ receives the message 118 and processes it to ascertain whether the online transaction attempted to be effected by the user 10 was approved or denied. Approval or denial (and a reason for denial, if applicable) may be recorded by the server 30ₙ for future reference. The server 30ₙ proceeds to send a message 120 to the computing device 16 of the end-user equipment 12 in order to communicate approval or denial of the online transaction to the user 10.

Upon receiving the message 120, the computing device 16 processes the message 120 so as to communicate approval or denial of the online transaction to the user 10. For example, this may be achieved by displaying a “transaction approved” or “transaction denied” message (or any conceivable variant thereof) on the display of the computing device 16.

Although in embodiments considered above the payment gateway 60, the server 70, the transaction validation server 51 and the server 30ₙ have been described as separate elements, this has been done for convenience and illustration only. It should therefore be understood that in certain embodiments, any two or more of the payment gateway 60, the server 70, the transaction validation server 51 and the server 30ₙ may be integrated into a single network element.

Also, while in embodiments considered above certain messages are exchanged between various elements of the architecture depicted in FIGS. 3 and 4, it will be appreciated that different messages may be exchanged in other embodiments.

In addition, although in embodiments considered above an association between (i) the transaction identifier for the online transaction (in this case, A7GY8P2) (ii) the temporal information regarding the particular time at which the user 10 attempted to effect the online transaction (in this case, 1:48 PM EST on Jan. 12, 2008); and (iii) the logical identifier assigned to the end-user equipment 12 (in this case, 211.104.103.102) is maintained by the transaction validation server 51, it should be appreciated that in various alternative embodiments, such an association may be maintained by any other network element, such as the payment gateway 60 or the server 70.

Furthermore, while in embodiments considered above the transaction identifier (in this case, A7GY8P2) for the online transaction was generated by the payment gateway 60 upon receipt of the message 104, it should be appreciated that in various alternative embodiments the transaction identifier may be generated by the payment gateway 60 later on in the transaction validation, such as upon receipt of the message 116 from the server 70, or by any other network element involved in validating or otherwise processing the online transaction at various instances, such as:
by the server 70 upon receipt of message 106 from the payment gateway 60;
by the transaction validation server 51 upon receipt of the message 108 from the server 70;
by the server 70 upon receipt of the message 114 from the transaction validation server 51;
by the server 30ₙ upon receipt of the message 102 from the computing device 16; or
by a shipping agent that produces a waybill.

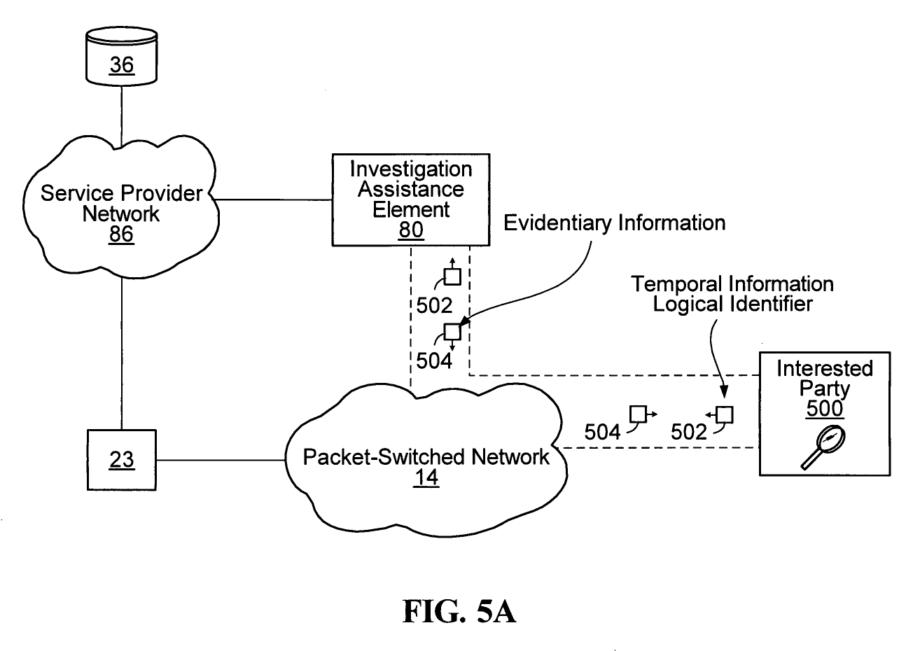

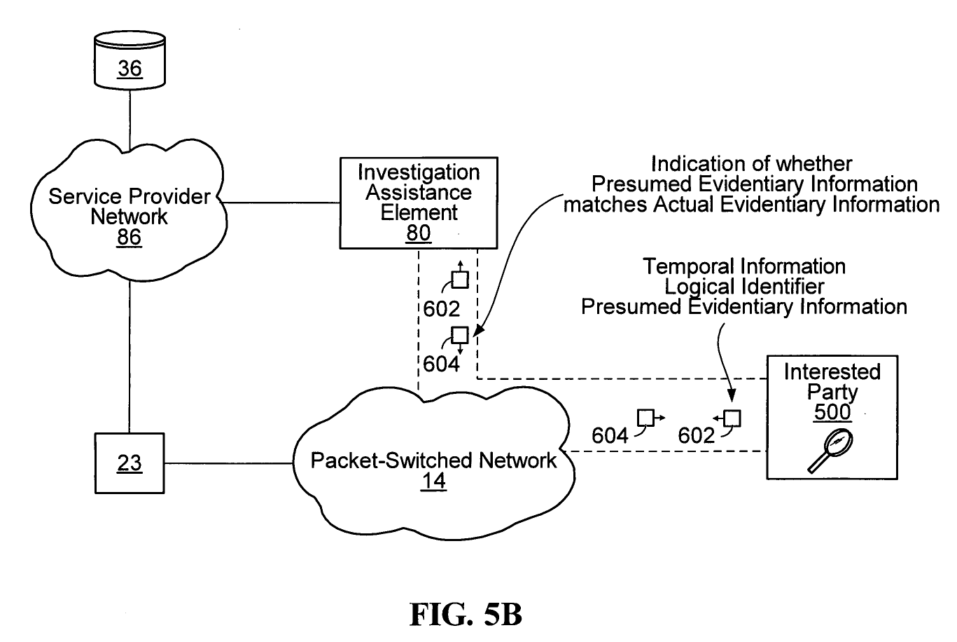

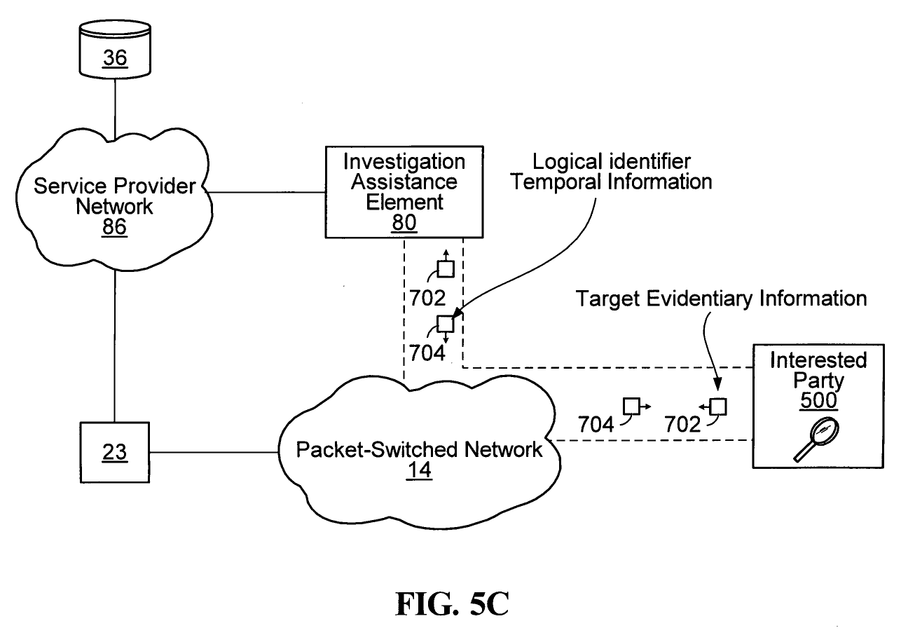

With additional reference now to FIGS. 5A to SC, examples of how the investigation assistance element 80 may be used to provide assistance in investigations of online transactions will be illustrated.

### FIRST EXAMPLE

FIG. 5A illustrates a first example in which it is assumed that, at the particular time when the user 10 attempted to effect the aforementioned online transaction using the end-user equipment 12, entities involved in processing this online transaction (such as the card issuing bank that issued the particular credit card used by the user 10) do not necessarily have an indication of whether this transaction is fraudulent or illegal. However, at some later time, let it be assumed that an interested party 500 (such as a merchant, a bank, a credit card company, a law enforcement agency, a governmental body, etc.) adopts a more suspicious view of the online transaction attempted to be effected by the user 10, which may have been approved or denied and which is hereinafter referred to as a “transaction of interest”. For instance, based on its own research, customer complaints, a fraud detection mechanism, and/or other factors, the interested party 500 may determine that the transaction of interest is potentially fraudulent or illegal. The interested party 500 may then undertake a forensic investigation regarding the transaction of interest.

As part of the investigation, the interested party 500 obtains certain information regarding the transaction of interest. More particularly, in this embodiment, the interested party 500 obtains (i) the temporal information regarding the particular time at which the user 10 attempted to effect the transaction of interest (in this case, 1:48 PM EST on Jan. 12, 2008) and (ii) the logical identifier assigned to the end-user equipment 12 (in this case, 211.104.103.102) when the transaction of interest was attempted to be effected. This information may be obtained by the interested party 500 upon being retrieved from the database 58 on a basis of the transaction identifier (in this case, A7GY8P2) for the transaction of interest. For example, this may be achieved either by the interested party 500 directly consulting the database 58 based on the transaction identifier, or by the transaction validation server 51 or another server having access to the database 58 retrieving the information therefrom based on the transaction identifier and providing it to the interested party 500.

The interested party 500 proceeds to send to the investigation assistance element 80 a message 502 conveying (i) the temporal information regarding the particular time at which the user 10 attempted to effect the transaction of interest (in this case, 1:48 PM EST on Jan. 12, 2008) and (ii) the logical identifier assigned to the end-user equipment 12 (in this case, 211.104.103.102) when the transaction of interest was attempted to be effected. The message 502 can be viewed as a request to obtain from the investigation assistance element 80 certain evidentiary information regarding specific end-user equipment (in this case, the end-user equipment 12) to which was assigned the logical identifier conveyed by the message 502 at a time specified by the temporal information conveyed by the message 502. In some embodiments, the message 502 may reach the investigation assistance element 80 via the packet-switched network 14 and the service provider network 86. In other embodiments, the message 502 may reach the investigation assistance element 80 via a direct link from the interested party 500.

The investigation assistance element 80 receives the message 502 and extracts therefrom the logical identifier 211.104.103.102 and the temporal information specifying the time “1:48 PM EST on January 12, 2008”. The investigation assistance element 80 proceeds to search the records 40₁ . . . 40_{M} of the database 36 for evidentiary information regarding any end-user equipment that may have been assigned logical identifier 211.104.103.102 at 1:48 PM EST on Jan. 12, 2008.

If a match is not found, the service provider has not stored a record specifying that logical identifier 211.104.103.102 was assigned to any end-user equipment which it served at 1:48 PM EST on Jan. 12, 2008. In this case, the investigation assistance element 80 may send to the interested party 500 a message (not shown) indicating that no match was found and thus that no evidentiary information was found, and the interested party 500 may wish to query other service providers who may have assigned logical identifier 211.104.103.102 to some end-user equipment at the relevant time.

On the other hand, if a match is found, as in this example where the record 40_{X} specifies that logical identifier 211.104.103.102 was assigned to the end-user equipment 12 from 10:34 AM EST on Jan. 12, 2008 to 3:19 PM EST on Jan. 13, 2008, the investigation assistance element 80 retrieves the evidentiary information regarding the end-user equipment 12 that is contained in the record 40_{X} (in this case, the identity of subscriber “ABC” such as his/her name and/or other personal information, as well the service point location “15 Main Street”) and sends a message 504 conveying part or all of this evidentiary information to the interested party 500. The level of detail provided in the message 504 may vary depending on a relationship between the interested party 500 and the service provider. For example, a law enforcement agency may be privy to a greater amount of detail concerning the evidentiary information than a credit card company.

In one embodiment, where the transaction of interest is known to be fraudulent (e.g., a fraudulent purchase, etc.), the evidentiary information provided in the message 504 may reveal to the interested party 500 certain details about a culprit of this fraudulent transaction. For example, when the evidentiary information provided in the message 504 comprises the service point location “15 Main Street”, then the interested party 500 may conclude where the fraudulent transaction of interest was made from. As another example, when the evidentiary information provided in the message 504 comprises the identity of subscriber “ABC”, then the interested party 500 may conclude who is guilty of having effected the fraudulent transaction of interest. Other example scenarios are of course possible, and each may lead to specific actions that may be taken by the interested party 500 to identify and then pursue and/or prosecute the culprit, as will be appreciated by those skilled in the art.

In another embodiment, the evidentiary information provided in the message 504 may reveal to the interested party 500 that the transaction of interest has a likelihood of having been fraudulent or illegal. For example, when the evidentiary information provided in the message 504 comprises the service point location “15 Main Street”, and if the particular credit card used by the user 10 is authorized to be at any of a limited set of locations which do not include the service point location “15 Main Street”, the interested party 500 may conclude that the transaction of interest was fraudulent. As another example, when the evidentiary information provided in the message 504 comprises the identity of subscriber “ABC”, and if subscriber “ABC” is found to be or is registered as being of a certain age, the interested party 500 may conclude that the transaction of interest was illegal. Other example scenarios are of course possible, and each may lead to specific actions that may be taken by the interested party 500 to further investigate the issue of fraud or illegality, as will be appreciated by those skilled in the art.

### SECOND EXAMPLE

FIG. 5B illustrates a second example in which, as in the first example considered above, it is assumed that the interested party 500 undertakes a forensic investigation of the online transaction attempted to be effected by the user 10, i.e., the transaction of interest.

As part of the investigation, the interested party 500 obtains certain information regarding the transaction of interest. More particularly, in this embodiment, the interested party 500 obtains: (i) the temporal information regarding the particular time at which the user 10 attempted to effect the transaction of interest (in this case, 1:48 PM EST on Jan. 12, 2008); (ii) the logical identifier assigned to the end-user equipment 12 (in this case, 211.104.103.102) when the transaction of interest was attempted to be effected; and (iii) “presumed evidentiary information” regarding the end-user equipment 12 used in attempting to effect the transaction of interest. For example, the presumed evidentiary information may include personal information (such as a name, age or date of birth, gender, telephone number, email address, etc.) regarding the holder of the particular credit card (in this case, John Smith) for which the credit card information (in this case, credit card holder “John Smith” and credit card number 4513000000001) has been provided via the end-user equipment 12 in attempting to effect the transaction of interest. Alternatively or additionally, the presumed evidentiary information may include location information indicative of a presumed physical location (e.g., a geo-location and/or a civic address) of the end-user equipment 12 when the transaction of interest was attempted to be effected.

The temporal information, the logical identifier and the presumed evidentiary information may be obtained by the interested party 500 upon being retrieved from the database 58 on a basis of the transaction identifier (in this case, A7GY8P2) for the transaction of interest. Also, in some cases, part or all of the presumed evidentiary information may be derived by accessing the record in the database 53 for the particular credit card used by the user 10 (and identified by the credit card information, in this case credit card holder “John Smith” and credit card number 4513000000001) in order to retrieve some of the ancillary information (e.g., a billing address, a list of one or more authorized transaction points, a list of one or more unauthorized transaction points, a list of eligible card holders' names, etc.) contained in that record. For example, the temporal information, the logical identifier and the presumed evidentiary information may be obtained by the interested party 500 either by directly consulting the database 58 (and possibly the database 53) based on the transaction identifier, or by the transaction validation server 51 or another server having access to the database 58 (and possibly the database 53) retrieving the information therefrom based on the transaction identifier and providing it to the interested party 500.

For purposes of this example, it is assumed that the presumed evidentiary information obtained by the interested party 500 includes a civic address from which the transaction of interest is presumed to have been attempted using the end-user equipment 12 (hereinafter referred to as the “presumed civic address”). The presumed civic address may be derived based on the ancillary information contained in the record in the database 53 for the particular credit card used by the user 10. For instance, the presumed civic address may correspond to an authorized transaction point or may be an address from which all or a vast majority of previous transactions using the particular credit card have been attempted.

The interested party 500 proceeds to send to the investigation assistance element 80 a message 602 conveying: (i) the temporal information regarding the particular time at which the user 10 attempted to effect the transaction of interest (in this case, 1:48 PM EST on Jan. 12, 2008); (ii) the logical identifier assigned to the end-user equipment 12 (in this case, 211.104.103.102) when the transaction of interest was attempted to be effected; and (iii) the presumed civic address from which the transaction of interest is presumed to have been attempted using the end-user equipment 12. The message 602 can be viewed as a request to obtain from the investigation assistance element 80 an indication of whether the presumed evidentiary information (in this case, the presumed civic address) conveyed by the message 602 matches certain evidentiary information (in this case, a certain civic address) regarding specific end-user equipment (in this case, the end-user equipment 12) to which was assigned the logical identifier conveyed by the message 602 at a time specified by the temporal information conveyed by the message 602. In some embodiments, the message 602 may reach the investigation assistance element 80 via the packet-switched network 14 and the service provider network 86. In other embodiments, the message 602 may reach the investigation assistance element 80 via a direct link from the interested party 500.

The investigation assistance element 80 receives the message 602 and extracts therefrom the logical identifier 211.104.103.102, the temporal information specifying the time “1:48 PM EST on January 12, 2008”, and the presumed civic address. The investigation assistance element 80 proceeds to search the records 40₁ . . . 40_{M} of the database 36 for evidentiary information regarding any end-user equipment that may have been assigned logical identifier 211.104.103.102 at 1:48 PM EST on Jan. 12, 2008.

If a match is not found, the service provider has not stored a record specifying that logical identifier 211.104.103.102 was assigned to any end-user equipment which it served at 1:48 PM EST on Jan. 12, 2008. In this case, the investigation assistance element 80 may send to the interested party 500 a message (not shown) indicating that no match was found and thus that no evidentiary information was found, and the interested party 500 may wish to query other service providers who may have assigned logical identifier 211.104.103.102 to some end-user equipment at the relevant time.

On the other hand, if a match is found, as in this example where the record 40_{X} specifies that logical identifier 211.104.103.102 was assigned to the end-user equipment 12 from 10:34 AM EST on Jan. 12, 2008 to 3:19 PM EST on Jan. 13, 2008, the investigation assistance element 80 retrieves the evidentiary information regarding the end-user equipment 12 that is contained in the record 40_{X} (in this case, the identity of subscriber “ABC” such as his/her name and/or other personal information, as well the service point location “15 Main Street”) and compares this “actual” evidentiary information to the presumed evidentiary information (in this case, the presumed civic address) obtained from the message 602. Based on a result of this comparison, the investigation assistance element 80 sends a message 604 to the interested party 500 to indicate whether the presumed evidentiary information conveyed by the message 602 corresponds to the actual evidentiary information retrieved from the record 40_{X}. Upon receiving the message 604, the interested party 500 may reach different conclusions about legitimacy of the transaction of interest depending on whether the presumed evidentiary information corresponds to the actual evidentiary information.

More particularly, in this example, if the presumed civic address conveyed by the message 602 corresponds to the service point location “15 Main Street” retrieved from the record 40_{X}, the investigation assistance element 80 generates the message 604 such that it indicates that there is match. Upon receiving the message 604, the interested party 500 concludes that the end-user equipment 12 to which was assigned logical identifier 211.104.103.102 at the particular time when the transaction of interest was attempted was indeed located at the presumed civic address (in this case, “15 Main Street”). In cases where the presumed civic address is derived from the record in the database 53 for the particular credit card used by the user 10 and is an authorized transaction point or an address from which all or a vast majority of previous transactions using the particular credit card have been attempted, the interested party 500 may conclude that the transaction of interest is unlikely to be fraudulent since it was attempted from an approved location. Alternatively, in situations where the interested party 500 has other information that leads it to believe that the transaction of interest is potentially fraudulent, the interested party 500 may conclude that, although it may be fraudulent, the transaction of interest was nevertheless attempted from an approved location.

If the presumed civic address conveyed by the message 602 does not correspond to the service point location “15 Main Street” retrieved from the record 40_{X}, the investigation assistance element 80 generates the message 604 such that it indicates that there is no match. Upon receiving the message 604, the interested party 500 concludes that the end-user equipment 12 to which was assigned logical identifier 211.104.103.102 at the particular time when the transaction of interest was attempted was not located at the presumed civic address (in this case, “15 Main Street”). In cases where the presumed civic address is derived from the record in the database 53 for the particular credit card used by the user 10 and is an authorized transaction point or an address from which all or a vast majority of previous transactions using the particular credit card have been attempted, the interested party 500 may conclude that the transaction of interest is potentially fraudulent since it was not attempted from an approved location.

Depending on conclusions that it reaches, the interested party 500 may take various actions to further investigate issues of fraud or illegality of the transaction of interest, including identifying and then pursuing and/or prosecuting a culprit in cases where the transaction of interest is deemed to be fraudulent or illegal.

It will be appreciated that, in this example, the investigation assistance element 80 can validate certain presumed evidentiary information regarding the transaction of interest (in this case, the presumed civic address) for the interested party 500 without providing actual evidentiary information stored in the database 36 to the interested party 500, thereby maintaining privacy of the actual evidentiary information stored in the database 36.

### THIRD EXAMPLE

FIG. 5C illustrates a third example in which it is assumed that the interested party 500 knows that a particular person and/or location is/are associated with one or more fraudulent transactions that have been previously attempted/effected. The interested party 500 may use “target evidentiary information” identifying the particular person and/or location and obtained by the interested party 500 during its investigation in order to investigate other fraudulent transactions that may have been attempted/effected by and/or at the particular person and/or location. For example, the target evidentiary information may include personal information (such as a name, age or date of birth, gender, telephone number, email address, etc.) regarding the particular person and/or location information indicative of the particular location (e.g., a geo-location and/or a civic address). Such an investigation may be useful when dealing with suspects or convicted criminals (e.g., fraudsters, prisoners or ex-prisoners, etc.).

In this embodiment, the interested party 500 sends to the investigation assistance element 80 a message 702 that conveys the target evidentiary information identifying the particular person and/or location. The message 702 can be viewed as a request to obtain from the investigation assistance element 80 a specific logical identifier and specific temporal information which may be associated in the database 36 with actual evidentiary information that matches the target evidentiary information.

Upon receipt of the message 702, the investigation assistance element 80 searches the database 36 for evidentiary information stored therein and matching the target evidentiary information conveyed by the message 702. More particularly, the investigation assistance element 80 consults the database 36 in an attempt to match the target evidentiary information conveyed by the message 702 with the evidentiary information stored in one of the records 40₁ . . . 40_{M}.

Assuming that the evidentiary information contained in a particular one of the records 40₁ . . . 40_{M} matches the target evidentiary information conveyed by the message 702, the investigation assistance element 80 retrieves the given logical identifier and the given temporal information contained in that particular record. For example, let it be assumed that the given logical identifier is 108.204.113.007 and the given temporal information specifies a period of time from 6:18 AM EST on Jan. 4, 2008 to 11:29 PM EST on Jan. 7, 2008. The investigation assistance element 80 proceeds to send to the interested party 500 a message 704 that conveys this logical identifier and temporal information.

While in this example it is assumed that a single “pair” of logical identifier/temporal information (i.e., 108.204.113.007/“6:18 AM EST on January 4, 2008 to 11:29 PM EST on January 7, 2008”) is associated with actual evidentiary information in the database 36 that matches the target evidentiary information conveyed by the message 702, it will be recognized that in some situations multiple such pairs of logical identifier/temporal information may be found in the database 36, in which case the message 704 transmitted to the interested party 500 may convey each of these multiple pairs of logical identifier/temporal information.

Upon receiving the message 704, the interested party 500 extracts therefrom the given logical identifier and the given temporal information. The interested party 500 then proceeds to obtain from the database 58 any transaction identifier for an online transaction that may have been attempted using end-user equipment to which was assigned logical identifier 108.204.113.007 between 6:18 AM EST on Jan. 4, 2008 and 11:29 PM EST on Jan. 7, 2008. In cases where one or more transaction identifiers meeting these criteria are obtained, the interested party 500 proceeds to identify one or more online transactions identified by these one or more transaction identifiers. The interested party 500 may proceed to investigate the one or more online transactions in order to determine whether they are fraudulent.

While the examples considered above in connection with FIGS. 5A to 5C illustrate certain ways in which the investigation assistance element 80 and the database 36 may be used to provide assistance in investigations of online transactions, it will be appreciated that such assistance may be provided in various other ways in other embodiments.

For example, in some embodiments, the interested party 500 may send to the investigation assistance element 80 a message conveying (i) a specific logical identifier, say 124.116.203.132, assigned to certain end-user equipment used in attempting to effect a transaction of interest and (ii) presumed evidentiary information regarding the certain end-user equipment (e.g., a presumed name of a user of the certain end-user equipment and/or a presumed civic address where the certain end-user equipment was located). Upon finding in the database 36 a particular one of the records 40₁ . . . 40_{M} that contains logical identifier 124.116.203.132 and actual evidentiary information matching the presumed evidentiary information, the investigation assistance element 80 may send to the interested party 500 a message conveying the temporal information contained in that particular record in order to allow the interested party 500 to reach various conclusions about fraud or illegality of the transaction of interest based on this temporal information (e.g., confirm whether this temporal information covers a time that matches a recorded time at which the transaction of interest was attempted to be effected).

As another example, in some embodiments, the interested party 500 may send to the investigation assistance element 80 a message conveying (i) temporal information specifying a particular time, say 3:15 PM EST on Jan. 6, 2008, at which a transaction of interest was attempted using certain end-user equipment and (ii) presumed evidentiary information regarding the certain end-user equipment (e.g., a presumed name of a user of the certain end-user equipment and/or a presumed civic address where the certain end-user equipment was located). Upon finding in the database 36 a particular one of the records 40₁ . . . 40_{M} that contains temporal information covering the particular time of 3:15 PM EST on Jan. 6, 2008 and actual evidentiary information matching the presumed evidentiary information, the investigation assistance element 80 may send to the interested party 500 a message conveying the logical identifier contained in that particular record in order to allow the interested party 500 to reach various conclusions about fraud or illegality of the transaction of interest based on this logical identifier (e.g., confirm whether this logical identifier matches a recorded logical identifier from which the transaction of interest was attempted to be effected).

In these two examples, the investigation assistance element 80 provides to the interested party 500 a specific logical identifier or specific temporal information that can be used by the interested party 500 as part of its investigation of a transaction of interest, without providing to the interested party 500 actual evidentiary information stored in the database 36, thereby maintaining its privacy.

While in embodiments considered above in connection with FIGS. 5A to 5C the messages 502, 504, 602, 604, 702, 704 are transmitted between the investigation assistance element 80 and the interested party 500 over the packet-switched network 14 and/or a direct link therebetween, in other embodiments, information conveyed by these messages may be conveyed via other types of messages, such as messages (e.g., spoken messages in person or over the phone, email messages, etc.) transmitted between individuals associated with the investigation assistance element 80 and the interested party 500. For example, in some embodiments, the request conveyed by the message 502, 602, 702 may be received by the service provider as part of one or more messages transmitted between the interested party 500 and an employee of the service provider allowed to use the investigation assistance element 80. In such embodiments, the investigation assistance element 80 may generate a given message conveying information similar to that conveyed by the message 504, 604, 704 and transmit this given message to the employee of the service provider, who may then proceed to transmit a message (e.g., verbally, via email, etc.) to the interested party 500 on a basis of this given message.

Also, while in examples considered above in relation to FIGS. 5A and 5B the interested party 500 obtains from the database 58 on a basis of the transaction identifier (in this case, A7GY8P2) for the transaction of interest (i) the temporal information regarding the particular time at which the user 10 attempted to effect the transaction of interest (in this case, 1:48 PM EST on Jan. 12, 2008), (ii) the logical identifier assigned to the end-user equipment 12 (in this case, 211.104.103.102) when the transaction of interest was attempted to be effected, and, in the example considered in FIG. 5B, (iii) the presumed evidentiary information regarding the end-user equipment 12 used in attempting to effect the transaction of interest, and proceeds to send the message 502, 602 conveying this information to the investigation assistance element 80 which responds by sending the message 504, 604 to the interested party 500 conveying the evidentiary information (FIG. 5A) or the indication of whether the presumed evidentiary information matches the actual evidentiary information (FIG. 5B), it will be appreciated that in other embodiments the interested party 500 may receive the message 504, 604 or information contained therein without ever having obtained the temporal information, the logical identifier or the presumed evidentiary information from the database 58. For instance, in an example scenario where the interested party 500 is a law enforcement agency which has knowledge that the transaction of interest identified by the transaction identifier A7GY8P2 is potentially fraudulent, the interested party 500 may request that the card issuing bank which issued the particular credit card used for the transaction of interest transmit the temporal information, the logical identifier and possibly the presumed evidentiary information to the investigation assistance element 80, which can proceed to send the message 504, 604 to the interested party 500 (or back to the card issuing bank which may proceed to transfer information conveyed by the message 504, 604 to the interested party 500).

In addition, although examples considered above relate to an online transaction involving an online purchase using a credit card, it will be recognized that principles described herein apply to other types of online transactions, including, for example, those involving online purchases or payments using other payment objects (e.g., digital cash, electronic checks), online fund transfers involving accounts (e.g., bank accounts, online wallet accounts), attempts to access secure online content; and attempts to access a virtual private network, to name a few non-limiting possibilities.

Furthermore, while embodiments considered above illustrate some examples in which the investigation assistance element 80 may be used to provide assistance in investigations of online transactions, it will be appreciated that the investigation assistance element 80 may be used to provide assistance in investigations of other types of online activities. For example, in some embodiments, the investigation assistance element 80 may access the database 36 to provided assistance to a party investigating one or more online browsing sessions or one or more online chat sessions conducted by one or more particular subscribers, at one or more particular times and/or from one or more particular locations. This may be used, for instance, to prove that a given individual visited illegally a specific network site (e.g., a child pornography web site) or participated in online chat sessions with a person (e.g. a child) that has gone missing or was murdered. It will be appreciated that the investigation assistance element 80 may be used to provide assistance in investigations of various other online activities and in various other scenarios.

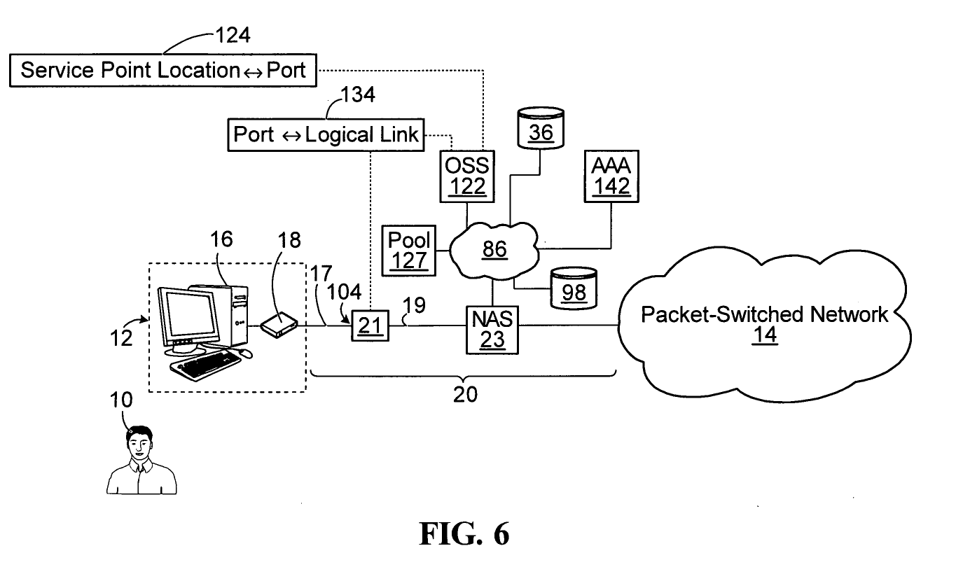

Turning now to FIG. 6, an example process by which the database 36 may be populated and maintained is described. This example process will illustrate one way in which the record 40_{X}, which associates logical identifier 211.104.103.102 assigned to the end-user equipment 12 from 10:34 AM EST on Jan. 12, 2008 to 3:19 PM EST on Jan. 13, 2008 with the evidentiary information regarding the end-user equipment 12 (in this case, the identity of subscriber “ABC” and the service point location “15 Main Street”), may be created.

The service provider provides a network access service to a given subscriber (in this case, subscriber “ABC”, who may or may not be the user 10) occupying, owning, managing or otherwise associated with service point where the end-user equipment 12 is located. In order to benefit from the network access service, the given subscriber has a business relationship with the service provider. As part of this business relationship, the given subscriber interacts with the service provider (e.g., during a registration or service activation phase) to provide personal information regarding itself. For example, this personal information may include a name, a gender, a date of birth or an age, a nationality, a correspondence language, a civic address (e.g., a residential or work address), a phone number (e.g., a residential, work, VoIP or mobile phone number), an email address, and/or an IM identifier of the given subscriber. If the given subscriber is more than one person, personal information regarding each such person may be provided. During interaction with the service provider, the given subscriber also indicates a service point location (e.g., a service address) where the network access service is to be delivered, selects a level of service to be obtained, provides billing information (e.g., a billing address and/or credit card information) to pay for the network access service, etc. Interaction between the given subscriber and the service provider may take place via a customer service representative of the service provider or via a web site implemented by the service provider.

Upon interacting with the given subscriber, the service provider maintains in a database 98 a profile associated with the given subscriber. The profile includes information provided by the given subscriber while interacting with the service provider and possibly other information not obtained from the given subscriber but pertaining to the network access service provided to the given party.

In this example, the network element 21 of the communication link 20 connecting the end-user equipment 12 to the packet-switched network 14 is an access multiplexer. In one embodiment, the access multiplexer 21 may be a DSLAM. The access multiplexer 21 is connected to the network element 23, which, in this embodiment, is a network access server (NAS). The NAS 23, which may also sometimes be referred to as a broadband remote access server (BRAS), a remote access server (RAS) or a broadband access server (BAS), provides access to the packet-switched network 14. Communication between the access multiplexer 21 and the NAS 23 can take place over the dedicated logical link 19 between these elements. The dedicated logical link 19, which may traverse an intervening access data network (not shown), can be implemented in various ways. For example, in one embodiment, the dedicated logical link 19 may be implemented as an asynchronous transfer mode (ATM) permanent virtual circuit (PVC). In another embodiment, the dedicated logical link 19 may be implemented as a virtual local area network (VLAN). It will be appreciated that various other implementations of the dedicated logical link 19 are possible.

The access multiplexer 21 allows data arriving from the NAS 23 along given ATM PVCs, VLANs or other dedicated logical links to be sent over corresponding physical links via corresponding one of its ports, and vice versa. Thus, the access multiplexer 21 can be said to implement a mapping 134 between, on the one hand, dedicated logical links and, on the other, ports of the access multiplexer 21. In this example, the mapping 134 implemented by the access multiplexer 21 relates the dedicated logical link 19 to the port 104 of the access multiplexer 21. In one example embodiment, the mapping 134 can be maintained by the access multiplexer 21.

In another example embodiment, the mapping 134 can be maintained by an operation support system (OSS) 122. The OSS 122 represents a collection of systems that perform management, inventory, engineering, planning, repair and other functions for a service provider. The OSS 122 may be connected to the NAS 23 via the service provider network 86. One of the functions of the OSS 122 may include management of network elements, assets and equipment. Thus, the OSS 122 maintains a mapping 124 between, on the one hand, ports of various access multiplexers or other network elements under control of the service provider and, on the other, service point locations of end user equipment (such as the end user equipment 12) connected to those ports. In this case, the mapping 124 maintained by the OSS 122 relates a port 104 of the network element 21 to a service point location, i.e., the location of a service point where the end-user equipment 12 is located. As mentioned previously, this service point location may be expressed as a civic address, a geo location, or any other information identifying where the service point is located. In this specific example, it is assumed that the service point location is “15 Main Street”.

The infrastructure shown in FIG. 6 further comprises an authorization element 142, which can be connected to the NAS 23 via the service provider network 86. The nature of the connection between the NAS 23 and the authorization element 142 is immaterial. For example, in one embodiment, the authorization element 142 may be a server (e.g., an Authentication, Authorization, and Accounting (AAA) server) responsive to queries from the NAS 23. In such an embodiment, the authorization element 142 and the NAS 23 may communicate using the Remote Authentication Dial In User Service (RADIUS) protocol, a description of which is available at www.ietf.org/rfc/rfc2865.txt. In another embodiment, the authorization element 142 may be a functional element integrated with the NAS 23.

In this example, the NAS 23 is operative to maintain a pool 127 of pre-allocated logical identifiers that can be used by various end-user equipment, including the end-user equipment 12. In some embodiments, the pool 127 of logical identifiers may be built up as a cooperative effort between the NAS 23 and the OSS 122, while in other embodiments, it may not be necessary for the OSS 122 to be involved in creating the pool 127 of logical identifiers. In still other embodiments, the pool 127 of logical identifiers may be maintained by the authorization element 142, and may be made accessible to the authorization element 142 without needing to pass through the NAS 23.

It will be appreciated that numerous modifications and variations of the infrastructure of FIG. 6 are possible. For example, in some embodiments, the access multiplexer 21 can be omitted. This may be true in embodiments where the end-user equipment 12 implements a wireless access point. For instance, in such embodiments, the connection between the wireless access point and the NAS 23 may be provided by a dedicated point-to-point link. As another example, in some embodiments, instead of the dedicated logical link 19, there may be a shared link leading to the end-user equipment 12.

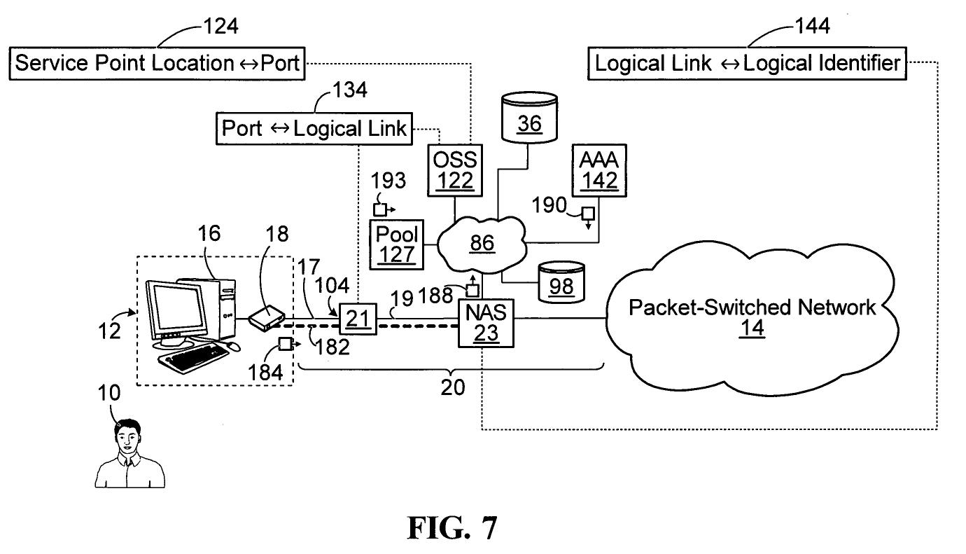

Reference is now made to FIG. 7, which illustrates an example of a possible event flow upon activation of the end-user equipment 12, which may occur, for instance, as the network interface unit 18 and/or the computing device 16 of the end-user equipment 12 is/are powered up. Thereafter:
a) the end-user equipment 12 establishes physical layer connectivity with the access multiplexer 21 over the physical link 17;
b) this is followed by establishment of Ethernet connectivity between the end-user equipment 12 and the access multiplexer 21;
c) the end-user equipment 12 verifies its ability to communicate using Point-to-Point Protocol over Ethernet (PPPoE). For a more detailed explanation of PPPoE, one may refer to Internet Request For Comments (RFC) 2516, available from the Internet Engineering Task Force (http://www.ietf.org), hereby incorporated by reference herein;
d) next, assuming that the end-user equipment 12 has the ability to communicate using PPPoE, the end-user equipment 12 verifies whether it should make a so-called “access request” automatically or in response to user input (which can be obtained via a software application). For purposes of this example, let it be assumed that conditions have been met such that the end-user equipment 12 should make an access request;
e) the end-user equipment 12 begins entry into PPPoE communication by broadcasting an “initiation” packet over the dedicated logical link 19;
f) the NAS 23 responds to receipt of the initiation packet by sending an “offer” packet to the end-user equipment 12. At this stage, it can be said that a logical connection 182 has been defined between a first endpoint (the end-user equipment 12) and a second endpoint (the NAS 23);
g) following receipt of the offer packet, the end-user equipment 12 sends an access request 184 to the NAS 23 with the ultimate goal of accessing the packet-switched network 14. The access request 184 may comprise credentials that can be hard coded or programmably installed on the end-user equipment 12. Alternatively, the credentials may be entered by the user 10 of the end-user equipment 12. For purposes of this example, assume that the credentials contained in the access request 184 are those of the given subscriber (i.e., subscriber “ABC”).
h) upon receipt of the access request 184 containing the credentials along the dedicated logical link 19, the NAS 23 executes an authorization procedure as follows. The NAS 23 communicates the credentials to the authorization element 142, e.g., via a RADIUS Access-Request message 188. In response to receipt of the credentials from the NAS 23, the authorization element 142 determines whether the credentials allow access to the packet-switched network 14. For example, this can be determined by consulting a database (not shown) of credentials for various subscribers. If the credentials allow access to the packet-switched network 14, the authorization element 142 returns an acceptance message (e.g., a RADIUS Access-Accept message). On the other hand, if the credentials do not allow access to the packet-switched network 14, the authorization element 142 returns a refusal message (e.g., a RADIUS Access-Reject message). For purposes of this example, assume that the credentials allow access to the packet-switched network 14, resulting in issuance of an acceptance message 190. In this example, two alternatives are possible
   alternative 1 (where the pool 127 of logical identifiers is maintained by the authorization element 142): the authorization element 142 obtains a logical identifier 193 (in this example, 211.104.103.102) from the pool 127 of logical identifiers that is maintained by the authorization element 142. The logical identifier 193 is sent to the NAS 23, which assigns the logical identifier 193 to the dedicated logical link 19;
   alternative 2 (where the pool 127 of logical identifiers is maintained by the NAS 23): responsive to receipt of the acceptance message 190 from the authorization element 142, the NAS 23 obtains a logical identifier 193 from the pool 127 of logical identifiers that is maintained by the NAS 23. The logical identifier 193 so obtained is assigned by the NAS 23 to the dedicated logical link 19.
i) the NAS 23 sends a “confirmation” packet back to the end-user equipment 12, thus completing establishment of a PPPoE session between the endpoints of the logical connection 182;
j) additional hand-shaking may be performed between the end-user equipment 12 and the NAS 23 in order to establish a Point-to-Point Protocol (PPP) session between the endpoints of the logical connection 182;
k) following this, further hand-shaking may be undertaken between the end-user equipment 12 and the NAS 23 in order to establish an Internet Protocol Control Protocol (IPCP) session between the endpoints of the logical connection 182.
l) during the IPCP session, the NAS 23 releases the logical identifier 193 towards the end-user equipment 12 that issued the access request 184, in order to allow the end-user equipment 12 to identify itself using the logical identifier 193 in future communications over the dedicated logical link 19. Since the dedicated logical link 19 to which has been assigned the logical identifier 193 leads to the end-user equipment 12 and since the end-user equipment 12 will identify itself using the logical identifier 193 in future communications, it can be said that the logical identifier 193 is in actuality assigned to the end-user equipment 12. The NAS 23 records the particular time at which the logical identifier 193 is assigned to the end-user equipment 12 (in this example, 10:34 AM EST on Jan. 12, 2008).

It can thus be appreciated that once the logical identifier 193 has been obtained from the pool 127 of logical identifiers (either by the NAS 23 or by the authorization element 142), the NAS 23 assigns the logical identifier 193 to the dedicated logical link 19.

In an embodiment where the database 36 is integrated with or connected directly to the NAS 23, the fact that the NAS 23 assigns the logical identifier 193 to the dedicated logical link 19 allows the NAS 23 to construct and maintain a mapping 144 between, on the one hand, various dedicated logical links (such as the dedicated logical link 19 and others) and, on the other, logical identifiers corresponding to those dedicated logical links.

In an embodiment where database 36 is integrated with or connected directly to the authorization element 142, the logical identifier 193 and the identity of the dedicated logical link 193 to which it is assigned are sent back by the NAS 23 to the authorization element 142, and it is the authorization element 142 that maintains the aforementioned mapping 144 between dedicated logical links and logical identifiers corresponding to those dedicated logical links.

Of course, those skilled in the art will be able to think of other ways of causing the end-user equipment 12 to send the access request 184 over the logical connection 182 between the end-user equipment 12 and the NAS 23, as well as other ways of assigning a logical identifier to the end-user equipment 12. It should further be mentioned that, in some cases, the establishment of the aforementioned PPPoE, PPP and/or IPCP sessions may not be required (e.g., where the dedicated logical link 19 is a VLAN, where DHCP is used directly, etc.).

In view of the preceding description, and in particular given the previously described mappings 124, 134 maintained in the OSS 122 and/or the access multiplexer 21 and the previously described mapping 144 maintained in the NAS 23 or the authorization element 142, the following describes how one can create an association between logical identifiers and service point locations.

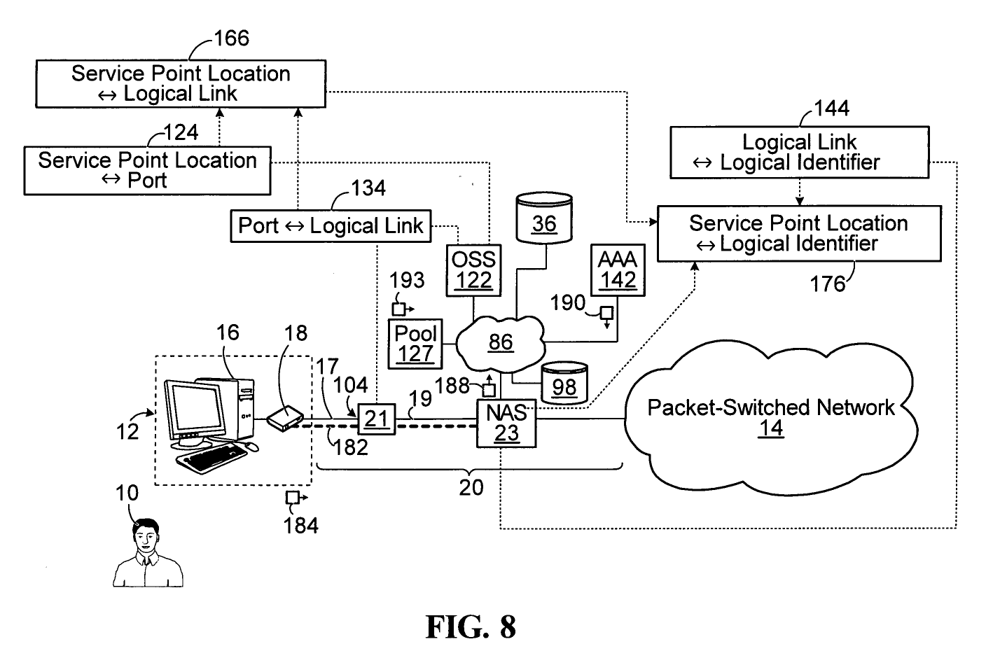

Specifically, with reference to FIG. 8, by combining the mapping 124 with the mapping 134, the OSS 122 can create an intermediate mapping 166 between, on the one hand, dedicated logical links and, on the other hand, service point locations of end-user equipment having logical connections with the NAS 23 which traverse those dedicated logical links. In this example, the intermediate mapping 166 would associate the dedicated logical link 19 to the service point location of the end-user equipment 12 (in this example, “15 Main Street”). In one embodiment, the OSS 122 transmits the intermediate mapping 166 to the database 36 (or a server associated therewith).

At the database 36 (or a server associated therewith), the intermediate mapping 166 received from the OSS 122 may be combined with the aforementioned mapping 144 (received from the NAS 23 or the authorization element 142), thus creating a final mapping 176 between, on the one hand, logical identifiers (such as IP addresses) and, on the other, service point locations of end-user equipment having logical connections with the NAS 23 which traverse respective dedicated logical links to which those logical identifiers have been assigned. In this example, the final mapping 176 would specify that the logical identifier 193 (in this example, 211.104.103.102) corresponds to the service point location of the end-user equipment 12 (in this example, “15 Main Street”).

In addition, based on the credentials provided along with the access request 184 (in this example, those of subscriber “ABC”), the NAS 23 (or another server) may retrieve information from the profile in the database 98 corresponding to these credentials, in this case, the identity of subscriber “ABC”.

With knowledge that logical identifier 211.104.103.102 was assigned to the end-user equipment 12 at 10:34 AM EST on Jan. 12, 2008, and with the final mapping 176 specifying that logical identifier 211.104.103.102 corresponds to the service point location “15 Main Street”, the NAS 23 (or another server associated therewith) may create the record 40_{X} in the database 36. At a later time, in this example, 3:19 PM EST on Jan. 13, 2008, the NAS 23 may determine that logical identifier 211.104.103.102 is no longer assigned to the end-user equipment 12, for instance, because access of the end-user equipment 12 to the packet-switched network 14 stopped or was lost or because another logical identifier was assigned to the end-user equipment 12. The NAS 23 (or another server associated therewith) may then update the record 40_{X} to reflect this.

It will be appreciated that in embodiments where logical identifiers are dynamically assigned to various end-user equipment (e.g., in a dynamic IP address system), the database 36 may be updated accordingly.

While the above-described example process illustrates one possible technique for populating a portion of the database 36, it will be appreciated that different techniques may be employed in different embodiments.

It should further be appreciated that although the above references to online activities have involved the computing device 16 effecting an online activity (e.g., an online transaction) with a network site over the packet-switched network 14, it is also within the scope of the invention for the computing device 16 to be implemented as a communication device which is one party to a call and which effects an online activity with another party reachable over the packet-switched network 14. Specifically, the communication device could be embodied as a VoIP phone, a Plain Old Telephone Service (POTS) phone equipped with an analog terminal adapter (ATA), or a soft phone (i.e., a computer equipped with telephony software). For its part, one party to the call can be a purveyor of goods or services.

Those skilled in the art will also appreciate that, in some embodiments, certain functionality of a given component described herein (e.g., the transaction validation server 51, the server 70, the payment gateway 60, the investigation assistance element 80, the servers 30₁ . . . 30_{N}) may be implemented as pre-programmed hardware or firmware elements (e.g., application specific integrated circuits (ASICs), electrically erasable programmable read-only memories (EEPROMs), etc.) or other related elements. In other embodiments, the given component may comprise a processor having access to a code memory which stores program instructions for operation of the processor to implement functionality of that given component. The program instructions may be stored on a medium which is fixed, tangible, and readable directly by the given component (e.g., removable diskette, CD-ROM, ROM, fixed disk, USB key, etc.). Alternatively, the program instructions may be stored remotely but transmittable to the given component via a modem or other interface device connected to a network over a transmission medium. The transmission medium may be either a tangible medium (e.g., optical or analog communications lines) or a medium implemented using wireless techniques (e.g., RF, microwave, infrared or other wireless transmission schemes).

Although various embodiments of the present invention have been described and illustrated, it will be apparent to those skilled in the art that numerous modifications and variations can be made without departing from the scope of the invention, which is defined in the appended claims.

What is claimed is:

1. A method for facilitating an investigation, said method comprising:
receiving a logical identifier and temporal information;
consulting a database to obtain evidentiary information regarding end-user equipment to which was assigned the logical identifier at a time specified by the temporal information; and
using the evidentiary information to transmit a message.

2. The method as claimed in claim 1, wherein the message conveys the evidentiary information.

3. The method as claimed in claim 1, wherein: the evidentiary information is actual evidentiary information; said method comprises receiving presumed evidentiary information; said using the actual evidentiary information comprises comparing the actual evidentiary information to the presumed evidentiary information; and the message indicates whether the presumed evidentiary information corresponds to the actual evidentiary information.

4. The method as claimed in claim 1, wherein the logical identifier comprises an IP address.

5. The method as claimed in claim 1, wherein the temporal information is indicative of at least one of: a time at which the logical identifier was initially assigned to the end-user equipment; and a period of time for which the logical identifier was assigned to the end-user equipment.

6. The method as claimed in claim 1, wherein the evidentiary information comprises location information regarding the end-user equipment.

7. The method as claimed in claim 6, wherein the location information is indicative of a location of a service point at which the end-user equipment gained access to a data network.

8. The method as claimed in claim 7, wherein the location of the service point is expressed as at least one of a civic address and a geo-location.

9. The method as claimed in claim 1, wherein the evidentiary information comprises personal information regarding a subscriber associated with the end-user equipment.

10. The method as claimed in claim 9, wherein the personal information comprises at least one of: a name, an age or date of birth, a gender, a telephone number, an email address, a service provider account identifier, and service provider billing information.

11. The method as claimed in claim 1, wherein the message is destined for a party conducting the investigation.

12. The method as claimed in claim 1, comprising assigning the logical identifier to the end-user equipment prior to said receiving the logical identifier.

13. The method as claimed in claim 1, comprising maintaining the database, the database including a plurality of logical identifiers assigned to respective end-user equipment to access a data network and, for each given logical identifier of the logical identifiers, certain temporal information regarding when the given logical identifier was assigned to the respective end-user equipment and certain evidentiary information regarding the respective end-user equipment.

14. The method as claimed in claim 1, wherein the investigation relates to an online activity initiated using the end-user equipment.

15. The method as claimed in claim 14, wherein the online activity is an online transaction.

16. The method as claimed in claim 14, wherein the online activity is one of an online browsing session and an online chat session.

17. A system for facilitating an investigation, said system comprising:
an interface configured to receive a logical identifier and temporal information; and
a processing unit coupled to said interface and configured to:
consult a database to obtain evidentiary information regarding end-user equipment to which was assigned the logical identifier at a time specified by the temporal information; and
use the evidentiary information to transmit a message.

18. The system as claimed in claim 17, wherein the message conveys the evidentiary information.

19. The system as claimed in claim 17, wherein: the evidentiary information is actual evidentiary information; said interface is configured to receive presumed evidentiary information; said processing unit being configured to use the actual evidentiary information comprises said processing unit being configured to compare the actual evidentiary information to the presumed evidentiary information; and the message indicates whether the presumed evidentiary information corresponds to the actual evidentiary information.

20. The system as claimed in claim 17, wherein the logical identifier comprises an IP address.

21. The system as claimed in claim 17, wherein the temporal information is indicative of at least one of: a time at which the logical identifier was initially assigned to the end-user equipment; and a period of time for which the logical identifier was assigned to the end-user equipment.

22. The system as claimed in claim 17, wherein the evidentiary information comprises location information regarding the end-user equipment.

23. The system as claimed in claim 22, wherein the location information is indicative of a location of a service point at which the end-user equipment gained access to a data network.

24. The system as claimed in claim 23, wherein the location of the service point is expressed as at least one of a civic address and a geo-location.

25. The system as claimed in claim 17, wherein the evidentiary information comprises personal information regarding a subscriber associated with the end-user equipment.

26. The system as claimed in claim 25, wherein the personal information comprises at least one of: a name, an age or date of birth, a gender, a telephone number, an email address, a service provider account identifier, and service provider billing information.

27. The system as claimed in claim 17, wherein the message is destined for a party conducting the investigation.

28. The system as claimed in claim 17, wherein said processing unit is configured to maintain the database, the database including a plurality of logical identifiers assigned to respective end-user equipment to access a data network and, for each given logical identifier of the logical identifiers, certain temporal information regarding when the given logical identifier was assigned to the respective end-user equipment and certain evidentiary information regarding the respective end-user equipment.

29. The system as claimed in claim 17, wherein the investigation relates to an online activity initiated using the end-user equipment.

30. The system as claimed in claim 29, wherein the online activity is an online transaction.

31. The system as claimed in claim 29, wherein the online activity is one of an online browsing session and an online chat session.

32. Computer-readable media containing program code which, when interpreted by a computing apparatus, causes the computing apparatus to execute a process for facilitating an investigation, the program code comprising:
first program code for causing the computing apparatus to be attentive to receipt of a logical identifier and temporal information;
second program code for causing the computing apparatus to consult a database to obtain evidentiary information regarding end-user equipment to which was assigned the logical identifier at a time specified by the temporal information; and
third program code for causing the computing apparatus to use the evidentiary information to cause transmission of a message.

33. A system for facilitating an investigation, said system comprising:
means for receiving a logical identifier and temporal information;
means for consulting a database to obtain evidentiary information regarding end-user equipment to which was assigned the logical identifier at a time specified by the temporal information; and
means for using the evidentiary information to transmit a message.

34. A method for investigating an online activity, said method comprising:
determining a logical identifier assigned to end-user equipment used for the online activity and a time of the online activity;
requesting an entity to obtain evidentiary information regarding the end-user equipment based on the logical identifier and the time;
receiving a message transmitted by the entity upon obtaining the evidentiary information; and
deriving a conclusion concerning the online activity based on the message.

35. The method as claimed in claim 34, wherein said determining comprises consulting a database based on information regarding the online activity in order to obtain the logical identifier and the time.

36. The method as claimed in claim 35, wherein the online activity is an online transaction and the information regarding the online transaction is a transaction identifier.

37. The method as claimed in claim 34, wherein the message conveys the evidentiary information.

38. The method as claimed in claim 34, wherein: the evidentiary information is actual evidentiary information; said method comprises transmitting to the entity presumed evidentiary information to allow the entity to compare the presumed evidentiary information to the actual evidentiary information; and the message indicates whether the presumed evidentiary information corresponds to the actual evidentiary information.

39. The method as claimed in claim 34, wherein the logical identifier comprises an IP address.

40. The method as claimed in claim 34, wherein the evidentiary information comprises location information regarding the end-user equipment.

41. The method as claimed in claim 40, wherein the location information is indicative of a location of a service point at which the end-user equipment gained access to a data network.

42. The method as claimed in claim 41, wherein the location of the service point is expressed as at least one of a civic address and a geo-location.

43. The method as claimed in claim 34, wherein the evidentiary information comprises personal information regarding a subscriber associated with the end-user equipment.

44. The method as claimed in claim 43, wherein the personal information comprises at least one of: a name, an age or date of birth, a gender, a telephone number, an email address, a service provider account identifier, and service provider billing information.

45. The method as claimed in claim 34, wherein the entity is a service provider having caused the logical identifier to be assigned to the end-user equipment.

46. The method as claimed in claim 34, wherein the online activity is an online transaction.

47. The method as claimed in claim 34, wherein the online activity is one of an online browsing session and an online chat session.

48. A method for conducting an investigation, said method comprising:
transmitting information regarding a particular person or location considered in the investigation;
receiving a logical identifier assigned to end-user equipment and temporal information regarding when the logical identifier was assigned to the end-user equipment, the logical identifier and the temporal information being associated in a database with the information regarding the particular person or location; and
identifying an online activity initiated using the end-user equipment to which was assigned the logical identifier at a time specified by the temporal information.

49. The method as claimed in claim 48, comprising investigating the online activity.

50. The method as claimed in claim 48, wherein the logical identifier comprises an IP address.

51. The method as claimed in claim 48, wherein the temporal information is indicative of at least one of: a time at which the logical identifier was initially assigned to the end-user equipment; and a period of time for which the logical identifier was assigned to the end-user equipment.

52. The method as claimed in claim 48, wherein the information regarding the particular person or location is indicative of a location of a service point at which the end-user equipment gained access to a data network.

53. The method as claimed in claim 52, wherein the location of the service point is expressed as at least one of a civic address and a geo-location.

54. The method as claimed in claim 48, wherein the information regarding the particular person or location comprises at least one of: a name, an age or date of birth, a gender, a telephone number, an email address, a service provider account identifier, and service provider billing information, associated with the particular person.

55. The method as claimed in claim 48, wherein the database is managed by a service provider having caused the logical identifier to be assigned to the end-user equipment.

56. The method as claimed in claim 48, wherein the online activity is an online transaction.

57. The method as claimed in claim 48, wherein the online activity is one of an online browsing session and an online chat session.

58. A method for facilitating an investigation, said method comprising:
receiving information regarding a particular person or location considered in the investigation;
consulting a database on a basis of the information regarding the particular person or location to obtain a logical identifier assigned to end-user equipment and temporal information regarding when the logical identifier was assigned to the end-user equipment; and
transmitting the logical identifier and the temporal information.

59. The method as claimed in claim 58, wherein the logical identifier comprises an IP address.

60. The method as claimed in claim 58, wherein the temporal information is indicative of at least one of: a time at which the logical identifier was initially assigned to the end-user equipment; and a period of time for which the logical identifier was assigned to the end-user equipment.

61. The method as claimed in claim 58, wherein the information regarding the particular person or location is indicative of a location of a service point at which the end-user equipment gained access to a data network.

62. The method as claimed in claim 61, wherein the location of the service point is expressed as at least one of a civic address and a geo-location.

63. The method as claimed in claim 58, wherein the information regarding the particular person or location comprises at least one of: a name, an age or date of birth, a gender, a telephone number, an email address, a service provider account identifier, and service provider billing information, associated with the particular person.

64. The method as claimed in claim 58, wherein said receiving, said consulting and said transmitting are performed by a service provider having caused the logical identifier to be assigned to the end-user equipment.

65. The method as claimed in claim 58, wherein the logical identifier and the temporal information are transmitted to a party conducting the investigation.

66. The method as claimed in claim 58, wherein the investigation relates to an online activity.

67. The method as claimed in claim 66, wherein the online activity is an online transaction.

68. The method as claimed in claim 66, wherein the online activity is one of an online browsing session and an online chat session.

69. A method for facilitating an investigation, said method comprising:
receiving first information comprising at least two of: a logical identifier assigned to end-user equipment; a particular time at which the end-user equipment was used for an online activity; and presumed evidentiary information regarding the end-user equipment;
consulting a database on a basis of the first information to obtain second information comprising:
the logical identifier, if the particular time and the presumed evidentiary information have been received;
temporal information regarding when the logical identifier was assigned to the end-user equipment, if the logical identifier and the presumed evidentiary information have been received; or
actual evidentiary information, if the logical identifier and the particular time have been received; and
using the second information to transmit a message in relation to the investigation.

70. The method as claimed in claim 69, wherein the message conveys the second information.

71. The method as claimed in claim 69, wherein, if the logical identifier, the particular time, and the presumed evidentiary information have been received, said using the actual evidentiary information comprises comparing the actual evidentiary information to the presumed evidentiary information, and the message indicates whether the presumed evidentiary information corresponds to the actual evidentiary information.

72. The method as claimed in claim 69, wherein the logical identifier comprises an IP address.

73. The method as claimed in claim 69, wherein the temporal information is indicative of at least one of: a time at which the logical identifier was initially assigned to the end-user equipment; and a period of time for which the logical identifier was assigned to the end-user equipment.

74. The method as claimed in claim 69, wherein the actual evidentiary information comprises location information regarding the end-user equipment.

75. The method as claimed in claim 74, wherein the location information is indicative of a location of a service point at which the end-user equipment gained access to a data network.

76. The method as claimed in claim 75, wherein the location of the service point is expressed as at least one of a civic address and a geo-location.

77. The method as claimed in claim 69, wherein the actual evidentiary information comprises personal information regarding a subscriber associated with the end-user equipment.

78. The method as claimed in claim 77, wherein the personal information comprises at least one of: a name, an age or date of birth, a gender, a telephone number, an email address, a service provider account identifier, and service provider billing information.

79. The method as claimed in claim 69, comprising assigning the logical identifier to the end-user equipment prior to said receiving.

80. The method as claimed in claim 69, comprising maintaining the database, the database including a plurality of logical identifiers assigned to respective end-user equipment to access a data network and, for each given logical identifier of the logical identifiers, certain temporal information regarding when the given logical identifier was assigned to the respective end-user equipment and certain evidentiary information regarding the respective end-user equipment.

81. The method as claimed in claim 69, wherein the investigation relates to an online activity for which the end-user equipment has been used.

82. The method as claimed in claim 81, wherein the online activity is an online transaction.

83. The method as claimed in claim 81, wherein the online activity is one of an online browsing session and an online chat session.

84. A system for facilitating an investigation, said system comprising:
an interface configured to receive first information comprising at least two of: a logical identifier assigned to end-user equipment; a particular time at which the end-user equipment was used for an online activity; and presumed evidentiary information regarding the end-user equipment; and
a processing unit coupled to said interface and configured to:
consult a database on a basis of the first information to obtain second information comprising:
the logical identifier, if the particular time and the presumed evidentiary information have been received;
temporal information regarding when the logical identifier was assigned to the end-user equipment, if the logical identifier and the presumed evidentiary information have been received; or
actual evidentiary information, if the logical identifier and the particular time have been received; and
use the second information to transmit a message in relation to the investigation.

85. The system as claimed in claim 84, wherein the message conveys the second information.

86. The system as claimed in claim 84, wherein, if the logical identifier, the particular time, and the presumed evidentiary information have been received, said processing unit being configured to use the actual evidentiary information comprises said processing unit being configured to compare the actual evidentiary information to the presumed evidentiary information, and the message indicates whether the presumed evidentiary information corresponds to the actual evidentiary information.

87. The system as claimed in claim 84, wherein the logical identifier comprises an IP address.

88. The system as claimed in claim 84, wherein the temporal information is indicative of at least one of: a time at which the logical identifier was initially assigned to the end-user equipment; and a period of time for which the logical identifier was assigned to the end-user equipment.

89. The system as claimed in claim 84, wherein the actual evidentiary information comprises location information regarding the end-user equipment.

90. The system as claimed in claim 89, wherein the location information is indicative of a location of a service point at which the end-user equipment gained access to a data network.

91. The system as claimed in claim 90, wherein the location of the service point is expressed as at least one of a civic address and a geo-location.

92. The system as claimed in claim 84, wherein the actual evidentiary information comprises personal information regarding a subscriber associated with the end-user equipment.

93. The system as claimed in claim 92, wherein the personal information comprises at least one of: a name, an age or date of birth, a gender, a telephone number, an email address, a service provider account identifier, and service provider billing information.

94. The system as claimed in claim 84, wherein said processing unit is configured to maintain the database, the database including a plurality of logical identifiers assigned to respective end-user equipment to access a data network and, for each given logical identifier of the logical identifiers, certain temporal information regarding when the given logical identifier was assigned to the respective end-user equipment and certain evidentiary information regarding the respective end-user equipment.

95. The system as claimed in claim 84, wherein the investigation relates to an online activity for which the end-user equipment has been used.

96. The system as claimed in claim 95, wherein the online activity is an online transaction.

97. The system as claimed in claim 95, wherein the online activity is one of an online browsing session and an online chat session.

98. Computer-readable media containing program code which, when interpreted by a computing apparatus, causes the computing apparatus to execute a process for facilitating an investigation, the program code comprising:
first program code for causing the computing apparatus to be attentive to receipt of first information comprising at least two of: a logical identifier assigned to end-user equipment; a particular time at which the end-user equipment was used for an online activity; and presumed evidentiary information regarding the end-user equipment;
second program code for causing the computing apparatus to consult a database on a basis of the first information to obtain second information comprising:
the logical identifier, if the particular time and the presumed evidentiary information have been received;
temporal information regarding when the logical identifier was assigned to the end-user equipment, if the logical identifier and the presumed evidentiary information have been received; or
actual evidentiary information, if the logical identifier and the particular time have been received; and
third program code for causing the computing apparatus to use the second information to cause transmission of a message in relation to the investigation.

99. A system for facilitating an investigation, said system comprising:
means for receiving first information comprising at least two of: a logical identifier assigned to end-user equipment; a particular time at which the end-user equipment was used for an online activity; and presumed evidentiary information regarding the end-user equipment;
means for consulting a database on a basis of the first information to obtain second information comprising:
the logical identifier, if the particular time and the presumed evidentiary information have been received;
temporal information regarding when the logical identifier was assigned to the end-user equipment, if the logical identifier and the presumed evidentiary information have been received; or
actual evidentiary information, if the logical identifier and the particular time have been received; and
means for using the second information to transmit a message in relation to the investigation.
